(19) United States
(12) Patent Application Publication
(10) Pub. No.: US 2025/0193648 A1
(43) Pub. Date: Jun. 12, 2025

(54) INTERFERENCE MEASUREMENT AND UPLINK POWER CONTROL ENHANCEMENTS FOR EMERGENCY MESSAGE RELAYING

(71) Applicant: QUALCOMM Incorporated, San Diego, CA (US)

(72) Inventors: Kangqi LIU, San Diego, CA (US); Alexei Yurievitch GOROKHOV, San Diego, CA (US); Qiaoyu LI, Beijing (CN); Ruiming ZHENG, Beijing (CN); Chao WEI, Beijing (CN); Mingxi YIN, Beijing (CN); Hao XU, Beijing (CN)

(21) Appl. No.: 18/840,017

(22) PCT Filed: Apr. 28, 2022
(86) PCT No.: PCT/CN2022/089818

§ 371 Date: Aug. 20, 2024

(51) Int. Cl. H04W 4/90; H04B 7/185; H04W 4/06

(52) U.S. Cl. CPC H04W 4/90; H04B 7/18506; H04W 4/06

(57) ABSTRACT

Methods, systems, and devices for wireless communications at one or more wireless devices are described. For example, a first network entity that serves a wireless device of an aircraft may transmit, to a second network entity serving one or more user equipments (UEs) in a terrestrial network, an indication that the second network entity is to report interference with the terrestrial network caused by broadcast emergency communications discovery signaling. The first network entity may receive, from the second network entity, a report comprising one or more indications of the interference. The first network entity may transmit, to the wireless device of the aircraft, an indication of one or more discovery signaling communication parameters for transmitting the broadcast emergency communications discovery signaling based at least in part on the one or more indications of the interference.

### CROSS REFERENCE

The present application is a 371 national stage filing of International PCT Application No. PCT/CN2022/089818 by LIU et al. entitled “INTERFERENCE MEASUREMENT AND UPLINK POWER CONTROL ENHANCEMENTS FOR EMERGENCY MESSAGE RELAYING,” filed Apr. 28, 2022, which is assigned to the assignee hereof, and which is expressly incorporated by reference in its entirety herein.

### FIELD OF TECHNOLOGY

The following relates to wireless communications, including interference measurement and uplink power control enhancements for emergency message relaying.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications system, a wireless device may engage in emergency communications (e.g., SOS messaging). However, methods for such emergency communications schemes may be improved/deficient.

### SUMMARY

The described techniques relate to improved methods, systems, devices, and apparatuses that support interference measurement and uplink power control enhancements for emergency (e.g., SOS message) relaying. For example, a user equipment (UE) may receive from a wireless device of an aircraft, broadcast emergency communications discovery signaling including one or more discovery signaling communication parameters for the UE outside a coverage area of a terrestrial communications network serving the UE. The UE may determine a transmit power level for transmitting an emergency message based on the one or more discovery signaling communication parameters. The UE may transmit the emergency message to the wireless device of the aircraft according to the determined transmit power level.

Additionally, or alternatively, a first network entity that serves a wireless device of an aircraft may transmit, to a second network entity serving one or more user equipments (UEs) in a terrestrial network, an indication that the second network entity is to report interference with the terrestrial network caused by broadcast emergency communications discovery signaling. The first network entity may receive, from the second network entity, a report comprising one or more indications of the interference. The first network entity may transmit, to the wireless device of the aircraft, an indication of one or more discovery signaling communication parameters for transmitting the broadcast emergency communications discovery signaling based at least in part on the one or more indications of the interference.

A method for wireless communication at a first user equipment (UE) is described. The method may include receiving, from a wireless device of an aircraft, broadcast emergency communications discovery signaling including one or more discovery signaling communication parameters for the UE outside a coverage area of a terrestrial communications network serving the UE, determining a transmit power level for transmitting an emergency message based on the one or more discovery signaling communication parameters, and transmitting the emergency message to the wireless device of the aircraft according to the determined transmit power level.

An apparatus for wireless communication at a first UE is described. The apparatus may include a processor, memory coupled with the processor, and instructions stored in the memory. The instructions may be executable by the processor to cause the apparatus to receive, from a wireless device of an aircraft, broadcast emergency communications discovery signaling including one or more discovery signaling communication parameters for the UE outside a coverage area of a terrestrial communications network serving the UE, determine a transmit power level for transmitting an emergency message based on the one or more discovery signaling communication parameters, and transmit the emergency message to the wireless device of the aircraft according to the determined transmit power level.

Another apparatus for wireless communication at a first UE is described. The apparatus may include means for receiving, from a wireless device of an aircraft, broadcast emergency communications discovery signaling including one or more discovery signaling communication parameters for the UE outside a coverage area of a terrestrial communications network serving the UE, means for determining a transmit power level for transmitting an emergency message based on the one or more discovery signaling communication parameters, and means for transmitting the emergency message to the wireless device of the aircraft according to the determined transmit power level.

A non-transitory computer-readable medium storing code for wireless communication at a first UE is described. The code may include instructions executable by a processor to receive, from a wireless device of an aircraft, broadcast emergency communications discovery signaling including one or more discovery signaling communication parameters for the UE outside a coverage area of a terrestrial communications network serving the UE, determine a transmit power level for transmitting an emergency message based on the one or more discovery signaling communication parameters, and transmit the emergency message to the wireless device of the aircraft according to the determined transmit power level.

Some examples of the method, apparatuses, and non-transitory computer-readable medium described herein may further include operations, features, means, or instructions for determining one or more path loss values associated with the broadcast emergency communications discovery signaling based on the one or more discovery signaling communication parameters and determining the transmit power level based on the one or more path loss values.

Some examples of the method, apparatuses, and non-transitory computer-readable medium described herein may further include operations, features, means, or instructions for receiving the one or more discovery signaling communication parameters including one or more power parameters associated with a beam-specific synchronization signal block, associated with a beam-specific reference signal, or any combination thereof and determining the transmit power level based on the one or more power parameters.

Some examples of the method, apparatuses, and non-transitory computer-readable medium described herein may further include operations, features, means, or instructions for receiving the one or more discovery signaling communication parameters including one or more indications of transmission power drifting information, determining one or more predictive discovery signaling communication parameters based on the one or more indications of transmission power drifting information, and determining the transmit power level based on the one or more predictive discovery signaling communication parameters.

Some examples of the method, apparatuses, and non-transitory computer-readable medium described herein may further include operations, features, means, or instructions for determining transmit power levels for one or more repetitions of the emergency message based on the one or more indications of transmission power drifting information and transmitting the one or more repetitions in accordance with the determined transmit power levels for the one or more repetitions of the emergency message.

Some examples of the method, apparatuses, and non-transitory computer-readable medium described herein may further include operations, features, means, or instructions for receiving one or more indications of emergency message repetition resources and transmitting one or more repetitions of the emergency message on the emergency message repetition resources.

In some examples of the method, apparatuses, and non-transitory computer-readable medium described herein, the first UE may be outside any coverage area of any terrestrial communications network.

In some examples of the method, apparatuses, and non-transitory computer-readable medium described herein, the broadcast emergency communications discovery signaling includes a synchronization signal block or an announcement message.

A method for wireless communication at a wireless device of an aircraft is described. The method may include transmitting a first emergency communications discovery signal, receiving, from a first network entity, an indication of one or more discovery signaling communication parameters, transmitting a second emergency communications discovery signal for establishing communications with a UE in accordance with the indication of the one or more discovery signaling communication parameters, and transmitting, to the UE, power control parameters associated with transmitting the second emergency communications discovery signal.

An apparatus for wireless communication at a wireless device of an aircraft is described. The apparatus may include a processor, memory coupled with the processor, and instructions stored in the memory. The instructions may be executable by the processor to cause the apparatus to transmit a first emergency communications discovery signal, receive, from a first network entity, an indication of one or more discovery signaling communication parameters, transmit a second emergency communications discovery signal for establishing communications with a UE in accordance with the indication of the one or more discovery signaling communication parameters, and transmit, to the UE, power control parameters associated with transmitting the second emergency communications discovery signal.

Another apparatus for wireless communication at a wireless device of an aircraft is described. The apparatus may include means for transmitting a first emergency communications discovery signal, means for receiving, from a first network entity, an indication of one or more discovery signaling communication parameters, means for transmitting a second emergency communications discovery signal for establishing communications with a UE in accordance with the indication of the one or more discovery signaling communication parameters, and means for transmitting, to the UE, power control parameters associated with transmitting the second emergency communications discovery signal.

A non-transitory computer-readable medium storing code for wireless communication at a wireless device of an aircraft is described. The code may include instructions executable by a processor to transmit a first emergency communications discovery signal, receive, from a first network entity, an indication of one or more discovery signaling communication parameters, transmit a second emergency communications discovery signal for establishing communications with a UE in accordance with the indication of the one or more discovery signaling communication parameters, and transmit, to the UE, power control parameters associated with transmitting the second emergency communications discovery signal.

Some examples of the method, apparatuses, and non-transitory computer-readable medium described herein may further include operations, features, means, or instructions for transmitting, to the UE, the power control parameters including one or more power parameters associated with a beam-specific synchronization signal block, associated with a beam-specific reference signal, or any combination thereof.

Some examples of the method, apparatuses, and non-transitory computer-readable medium described herein may further include operations, features, means, or instructions for transmitting, to the UE, the power control parameters including one or more indications of transmission power drifting information.

Some examples of the method, apparatuses, and non-transitory computer-readable medium described herein may further include operations, features, means, or instructions for receiving an emergency message from the UE and transmitting the emergency message to the first network entity.

Some examples of the method, apparatuses, and non-transitory computer-readable medium described herein may further include operations, features, means, or instructions for transmitting, to the UE, one or more indications of emergency message repetition resources and receiving one or more repetitions of an emergency message on the emergency message repetition resources.

In some examples of the method, apparatuses, and non-transitory computer-readable medium described herein, the first emergency communications discovery signal and the second emergency communications discovery signal each include a synchronization signal block or an announcement message.

In some examples of the method, apparatuses, and non-transitory computer-readable medium described herein, the wireless device of the aircraft operates as a base station or a UE.

A method for wireless communication at a first network entity that serves a wireless device of an aircraft is described. The method may include transmitting, to a second network entity serving one or more user equipments (UEs) in a terrestrial network, an indication that the second network entity is to report interference with the terrestrial network caused by broadcast emergency communications discovery signaling, receiving, from the second network entity, a report including one or more indications of the interference, and transmitting, to the wireless device of the aircraft, an indication of one or more discovery signaling communication parameters for transmitting the broadcast emergency communications discovery signaling based on the one or more indications of the interference.

An apparatus for wireless communication at a first network entity that serves a wireless device of an aircraft is described. The apparatus may include a processor, memory coupled with the processor, and instructions stored in the memory. The instructions may be executable by the processor to cause the apparatus to transmit, to a second network entity serving one or more user equipments (UEs) in a terrestrial network, an indication that the second network entity is to report interference with the terrestrial network caused by broadcast emergency communications discovery signaling, receive, from the second network entity, a report including one or more indications of the interference, and transmit, to the wireless device of the aircraft, an indication of one or more discovery signaling communication parameters for transmitting the broadcast emergency communications discovery signaling based on the one or more indications of the interference.

Another apparatus for wireless communication at a first network entity that serves a wireless device of an aircraft is described. The apparatus may include means for transmitting, to a second network entity serving one or more user equipments (UEs) in a terrestrial network, an indication that the second network entity is to report interference with the terrestrial network caused by broadcast emergency communications discovery signaling, means for receiving, from the second network entity, a report including one or more indications of the interference, and means for transmitting, to the wireless device of the aircraft, an indication of one or more discovery signaling communication parameters for transmitting the broadcast emergency communications discovery signaling based on the one or more indications of the interference.

A non-transitory computer-readable medium storing code for wireless communication at a first network entity that serves a wireless device of an aircraft is described. The code may include instructions executable by a processor to transmit, to a second network entity serving one or more user equipments (UEs) in a terrestrial network, an indication that the second network entity is to report interference with the terrestrial network caused by broadcast emergency communications discovery signaling, receive, from the second network entity, a report including one or more indications of the interference, and transmit, to the wireless device of the aircraft, an indication of one or more discovery signaling communication parameters for transmitting the broadcast emergency communications discovery signaling based on the one or more indications of the interference.

Some examples of the method, apparatuses, and non-transitory computer-readable medium described herein may further include operations, features, means, or instructions for transmitting, to the second network entity, the wireless device of the aircraft, or both, one or more indications of resource allocation associated with the broadcast emergency communications discovery signaling.

Some examples of the method, apparatuses, and non-transitory computer-readable medium described herein may further include operations, features, means, or instructions for determining the one or more indications of resource allocation based on a location of the aircraft, a trajectory of the aircraft, information associated with the aircraft, or any combination thereof.

Some examples of the method, apparatuses, and non-transitory computer-readable medium described herein may further include operations, features, means, or instructions for transmitting, to the second network entity, a position of the aircraft, a trajectory of the aircraft, or both.

Some examples of the method, apparatuses, and non-transitory computer-readable medium described herein may further include operations, features, means, or instructions for selecting one or more transmission power parameters based on the one or more indications of the interference and transmitting, to the wireless device of the aircraft, an indication of the one or more transmission power parameters.

Some examples of the method, apparatuses, and non-transitory computer-readable medium described herein may further include operations, features, means, or instructions for receiving the report including one or more beam indices associated with the interference and transmitting, to the wireless device of the aircraft, an indication of the one or more beam indices.

In some examples of the method, apparatuses, and non-transitory computer-readable medium described herein, the broadcast emergency communications discovery signaling includes a synchronization signal block or an announcement message.

A method for wireless communication at a second network entity serving one or more user equipments (UEs) in a terrestrial network is described. The method may include receiving, from a wireless device of an aircraft, broadcast emergency communications discovery signaling that causes interference with communications in the terrestrial network, receiving, from a first network entity that serves the wireless device of the aircraft, an indication that the second network entity is to report one or more indications of the interference, and transmitting, to the first network entity, a report including the one or more indications of the interference.

An apparatus for wireless communication at a second network entity serving one or more user equipments (UEs) in a terrestrial network is described. The apparatus may include a processor, memory coupled with the processor, and instructions stored in the memory. The instructions may be executable by the processor to cause the apparatus to receive, from a wireless device of an aircraft, broadcast emergency communications discovery signaling that causes interference with communications in the terrestrial network, receive, from a first network entity that serves the wireless device of the aircraft, an indication that the second network entity is to report one or more indications of the interference, and transmit, to the first network entity, a report including the one or more indications of the interference.

Another apparatus for wireless communication at a second network entity serving one or more user equipments (UEs) in a terrestrial network is described. The apparatus may include means for receiving, from a wireless device of an aircraft, broadcast emergency communications discovery signaling that causes interference with communications in the terrestrial network, means for receiving, from a first network entity that serves the wireless device of the aircraft, an indication that the second network entity is to report one or more indications of the interference, and means for transmitting, to the first network entity, a report including the one or more indications of the interference.

A non-transitory computer-readable medium storing code for wireless communication at a second network entity serving one or more user equipments (UEs) in a terrestrial network is described. The code may include instructions executable by a processor to receive, from a wireless device of an aircraft, broadcast emergency communications discovery signaling that causes interference with communications in the terrestrial network, receive, from a first network entity that serves the wireless device of the aircraft, an indication that the second network entity is to report one or more indications of the interference, and transmit, to the first network entity, a report including the one or more indications of the interference.

Some examples of the method, apparatuses, and non-transitory computer-readable medium described herein may further include operations, features, means, or instructions for transmitting, to the first network entity, the report including one or more indications of downlink interference measured at the one or more UEs.

Some examples of the method, apparatuses, and non-transitory computer-readable medium described herein may further include operations, features, means, or instructions for transmitting, to the one or more UEs, an indication of one or more resources that may be subject to the interference.

Some examples of the method, apparatuses, and non-transitory computer-readable medium described herein may further include operations, features, means, or instructions for transmitting, to the first network entity, the report including one or more indications of uplink interference measured at the second network entity.

Some examples of the method, apparatuses, and non-transitory computer-readable medium described herein may further include operations, features, means, or instructions for transmitting, to the first network entity, the report including one or more indications of beam indices associated with the broadcast emergency communications discovery signaling.

Some examples of the method, apparatuses, and non-transitory computer-readable medium described herein may further include operations, features, means, or instructions for receiving one or more indications of resource allocation associated with the broadcast emergency communications discovery signaling.

Some examples of the method, apparatuses, and non-transitory computer-readable medium described herein may further include operations, features, means, or instructions for determining one or more resource elements subject to the interference based on the one or more indications of resource allocation and transmitting the report including the one or more indications of interference associated with the one or more resource elements.

In some examples of the method, apparatuses, and non-transitory computer-readable medium described herein, where the broadcast emergency communications discovery signaling includes a synchronization signal block or an announcement message.

### BRIEF DESCRIPTION OF THE DRAWINGS

FIG. 1 illustrates an example of a wireless communications system that supports interference measurement and uplink power control enhancements for emergency message relaying in accordance with one or more aspects of the present disclosure.

FIG. 2 illustrates an example of a wireless communications system that supports interference measurement and uplink power control enhancements for emergency message relaying in accordance with one or more aspects of the present disclosure.

FIG. 3 illustrates an example of a process flow that supports interference measurement and uplink power control enhancements for emergency message relaying in accordance with one or more aspects of the present disclosure.

FIG. 4 illustrates an example of a process flow that supports interference measurement and uplink power control enhancements for emergency message relaying in accordance with one or more aspects of the present disclosure.

FIG. 5 illustrates an example of a process flow that supports interference measurement and uplink power control enhancements for emergency message relaying in accordance with one or more aspects of the present disclosure.

FIGS. 6 and 7 show block diagrams of devices that support interference measurement and uplink power control enhancements for emergency message relaying in accordance with one or more aspects of the present disclosure.

FIG. 8 shows a block diagram of a communications manager that supports interference measurement and uplink power control enhancements for emergency message relaying in accordance with one or more aspects of the present disclosure.

FIG. 9 shows a diagram of a system including a device that supports interference measurement and uplink power control enhancements for emergency message relaying in accordance with one or more aspects of the present disclosure.

FIGS. 10 and 11 show block diagrams of devices that support interference measurement and uplink power control enhancements for emergency message relaying in accordance with one or more aspects of the present disclosure.

FIG. 12 shows a block diagram of a communications manager that supports interference measurement and uplink power control enhancements for emergency message relaying in accordance with one or more aspects of the present disclosure.

FIG. 13 shows a diagram of a system including a device that supports interference measurement and uplink power control enhancements for emergency message relaying in accordance with one or more aspects of the present disclosure.

FIGS. 14 and 15 show block diagrams of devices that support interference measurement and uplink power control enhancements for emergency message relaying in accordance with one or more aspects of the present disclosure.

FIG. 16 shows a block diagram of a communications manager that supports interference measurement and uplink power control enhancements for emergency message relaying in accordance with one or more aspects of the present disclosure.

FIG. 17 shows a diagram of a system including a device that supports interference measurement and uplink power control enhancements for emergency message relaying in accordance with one or more aspects of the present disclosure.

FIGS. 18 through 21 show flowcharts illustrating methods that support interference measurement and uplink power control enhancements for emergency message relaying in accordance with one or more aspects of the present disclosure.

### DETAILED DESCRIPTION

In the course of wireless communications, a user equipment (UE) may not always be located within range of a terrestrial network entity (e.g., a base station) with which the UE may communicate. For example, the UE may be within coverage of one or more other terrestrial communications networks, but outside its own terrestrial communications network. Or, the UE may be outside the coverage of any terrestrial communications network. Such a UE may be referred to as a remote UE. To offer or provide wireless communications connectivity (e.g., for SOS or emergency communications) to such remote UEs, aircraft may be fitted with communications equipment so that the remote UE may communicate with the aircraft and communications may be relayed from the aircraft to a communications network (e.g., via an air-to-ground (ATG) network entity, such as an ATG base station). A typical cruising altitude of commercial aircraft (e.g., 10 km) may offer line of sight propagation of over 200 km and given typical densities of commercial aircraft traffic, at least one aircraft may be available for such SOS or emergency communications with remote UEs (e.g., within 50 to 100 km) in major remote areas (e.g., of the United States). However, to establish the SOS or emergency communications with remote UEs, the aircraft may initiate discovery signal transmissions (e.g., synchronization signal blocks (SSBs) or discovery announcement signals) that may cause significant interference with terrestrial wireless communications (e.g., another terrestrial UE operating within a coverage area of a network entity or base station). Further, as the aircraft travels relative to the remote UE, changes

To reduce or eliminate such interference, various operations may be performed. In some examples, the ATG network entity may indicate to the terrestrial network entity to measure and report downlink interference caused by the aircraft's discovery signal transmissions. Based on such interference measurement results, the ATG network entity may indicate to the aircraft to use different transmission parameters (e.g., power control parameters for different beams) for transmitting the discovery signal transmissions. Further, the aircraft may indicate transmission power drifting information that may change as transmission power is adjust. The remote UE may use information to predict per-beam transmit power, which may be used for downlink pathloss calculations, uplink power control, or both. In these ways, interference to terrestrial wireless communications operations may be reduced while still offering effective discovery of and communication with remote UEs by aircraft.

Aspects of the disclosure are initially described in the context of wireless communications systems. Aspects of the disclosure are then described in the context of a wireless communications system and process flows. Aspects of the disclosure are further illustrated by and described with reference to apparatus diagrams, system diagrams, and flowcharts that relate to interference measurement and uplink power control enhancements for emergency message relaying.

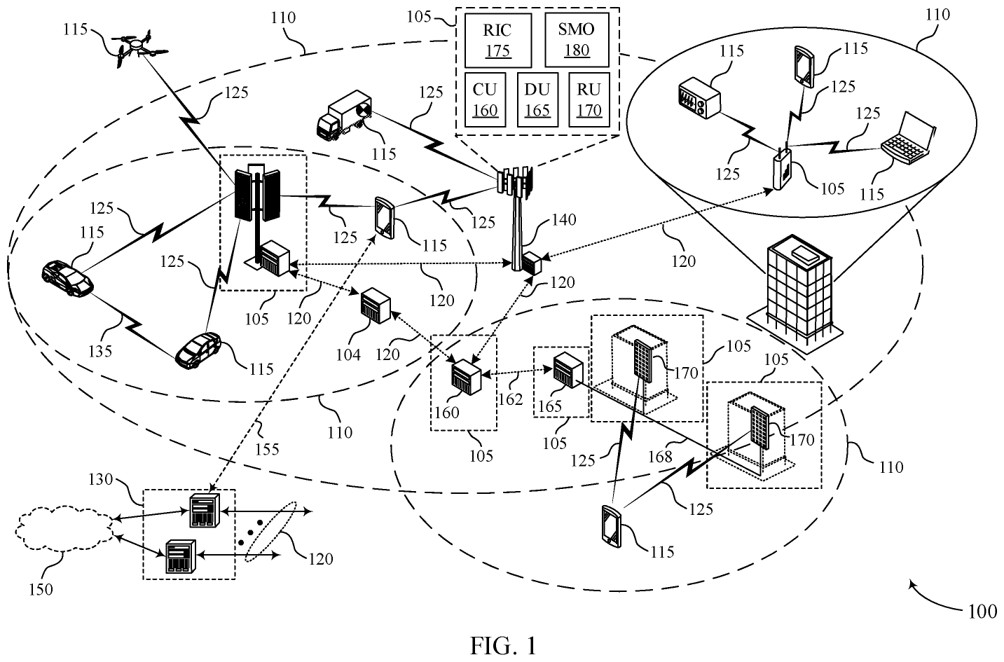

FIG. 1 illustrates an example of a wireless communications system 100 that supports interference measurement and uplink power control enhancements for emergency message relaying in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support interference measurement and uplink power control enhancements for emergency message relaying as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some implementations, one or more wireless devices (e.g., one or more UEs 115, one or more network entities 105, or any combination thereof) may support one or more signaling- or configuration-based mechanisms for emergency communications discovery and signaling according to which such wireless. For example, a wireless device of an aircraft may transmit an emergency communications discovery signal to aid in discovery of a UE 115 that may be operating outside a coverage area of a terrestrial wireless network. However, such discovery signaling may interfere with operations of one or more terrestrial wireless networks. A network entity 105 that serves the wireless device of the aircraft may request that the terrestrial network (e.g., a network entity 105 of such a terrestrial network) provide one or more indications of the interference caused by the emergency communications discovery signal. The network entity 105 serving the wireless device of the aircraft may transmit one or more parameters for transmission of the discovery signaling to the wireless device of the aircraft (e.g., to reduce the interference caused at the terrestrial network). In this way, emergency communications operations may be performed (e.g., including discovery of devices) while reducing or eliminating interference at other communications devices caused by the emergency communications operations.

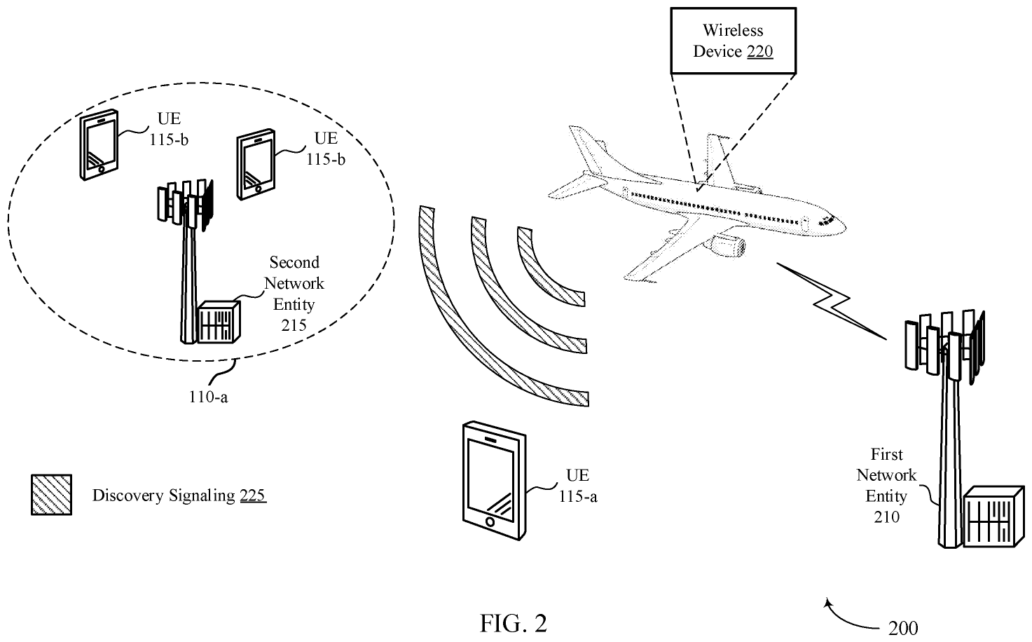

FIG. 2 illustrates an example of a wireless communications system 200 that supports interference measurement and uplink power control enhancements for emergency message relaying in accordance with one or more aspects of the present disclosure.

The wireless communications system 200 may include or involve the first network entity 210, the second network entity 215, or both, that may be examples of one or more of network entities discussed in relation to other figures. The wireless communications system 200 may include or involve the UE 115-a, the UEs 115-b, or any combination thereof that may be examples of UEs discussed in relation to other figures. The wireless communications system 200 may involve or include the wireless device 220, which may be located on an aircraft as depicted in FIG. 2.

In some examples, the wireless device 220 may communicate with the first network entity 210 via one or more communication links. In some examples, the UEs 115-b may be located in a geographic coverage area 110-a that may be associated with the second network entity 215. The second network entity 215 and UE 115-a may communicate via one or more downlink communication links, one or more uplink communication links, one or more sidelink communication links, or any combination thereof. In some examples, the UE 115-a may be located outside of a coverage area of a network entity, such as the coverage area 110-a. In some examples, the UE 115-a may be located outside of any coverage area of a network entity or may be located inside a coverage area of one or more network entities.

ATG communications may involve communications between one or more wireless devices in the air (e.g., on an aircraft or other vehicle) and one or more wireless devices on the ground. In some examples of ATG communications, a network entity (e.g., a base station or gNB) may be equipped with an antenna (e.g., an up-tilting antenna) for communication with a wireless device in the air. A wireless device in the air may be equipped with or connected to an antenna (e.g., on the aircraft) for communications with the ground-based wireless devices. Such an airborne wireless device may act as either a network entity, a UE, or both. In some examples, an airborne wireless device may be connected with customer premise equipment (CPE), such as devices used by people in the aircraft. As an aircraft travels, an airborne wireless device may communicate with multiple ground-based wireless devices (e.g., multiple network entities, base stations, gNBs such as ATG-gNBs, other devices, or any combination thereof).

ATG communications may involve various types of traffic, such an in-flight passenger communications, airline operations communications, air traffic control, other communications, or any combination thereof. In-flight passenger communications may include en-route communications, takeoff/landing communications, climb/descent communications, or any combination thereof. Airline operation communications may include communications regarding aircraft maintenance, flight planning, weather, other communications, or any combination thereof. Air traffic control communications may include communications that may be used as a back-up to systems used in aviation-licensed bands.

In addition or as alternatives to such uses, ATG communications may be used in emergency situations. For example, commercial aircraft could be used for emergency or SOS message relays for UEs that may not be located in a coverage area or may not be capable of communications in a location. Such a UE may be referred to as a remote UE. In such situations, a wireless device on an aircraft at a typical cruising altitude (e.g., 10 km) may provide opportunities for line-of-sight propagation of various distances (e.g., over 200 km). Though the density of commercial aircraft may vary based on time and region, in many remote areas (e.g., of the United States), one or more aircraft may be visible at a distance that may be reasonable for communication (e.g., 50-100 km or other distances). However, in some instances, ATG communications and ground-based or terrestrial communications may share some common frequencies. As such, a potential for interference at ground-based/terrestrial communications network caused by ATG communications exists.

In some approaches, a remote UE may initiate an emergency or SOS message transmission. Allowing a remote UE to initiate such messaging (e.g., in one or more preserved or dedicated resources) may reduce or eliminate interference from a wireless device of an aircraft actively transmitting. In some examples, however, such a UE may consume extra energy in blindly transmitting the emergency or SOS message.

In some approaches, an airborne wireless device may regularly or constantly broadcast discovery signaling to allow remote UEs to be discovered to initiate emergency or SOS messaging, and the airborne wireless device may operate as a network entity or a UE. For example, an airborne wireless device acting as a network entity (e.g., a gNB, IAB, a base station, or other network entity) may transmit a paging early indication (PEI), paging signaling, or both. In other examples, if another entity (e.g., a satellite) transmits a PEI, paging signaling, or both, an airborne wireless device may operate as either a network entity or a UE.

In addition, an airborne wireless device may transmit different types of discovery signaling depending on whether it is operating as a network entity or a UE. For example, an airborne wireless device may broadcast discovery signaling (e.g., a synchronization signal block (SSB) or other discovery signaling) when operating as a network entity (e.g., a gNB, IAB, or other network entity) and may broadcast a discovery announcement signal when operating as a UE. In one or both cases, such transmissions may cause a level of interference with terrestrial communications in a terrestrial communications network. In some examples, such approaches of an airborne wireless device transmitting such signaling may be used since the airborne wireless device may not otherwise be aware of remote UEs that may be used for emergency or SOS communications.

Therefore, in examples where such discovery signaling is employed, approaches for reducing the interference at terrestrial communications networks caused by the discovery signaling may be employed. For example, the wireless device 220 may broadcast the discovery signaling 225 in attempts to discover the UE 115-a (an example of a remote UE). In some examples, the second network entity 215 may receive signaling from the first network entity 210 indicating that the second network entity 215 is to measure and report interference (e.g., downlink interference at one or more of the UEs 115-b, uplink interference at the second network entity 215, or both) caused by the discovery signaling. Based on such measurements or reporting, the first network entity 210 may indicate to the wireless device 220 to use or adjust one or more communication parameters (transmission power parameters, optionally for different beams) for transmitting the discovery signaling 225. The wireless device 220 may transmit an indication of some or all such parameters or configurations to the UE 115-a to assist the UE 115-a in communications (e.g., for downlink pathloss calculations, uplink power control, other communications operations, or any combination thereof). Further, in some examples, the wireless device 220 may engage in beam steering operations. In some such examples, the wireless device 220 may indicate transmit power drifting information to the UE 115-a to further assist the UE 115-a in communications.

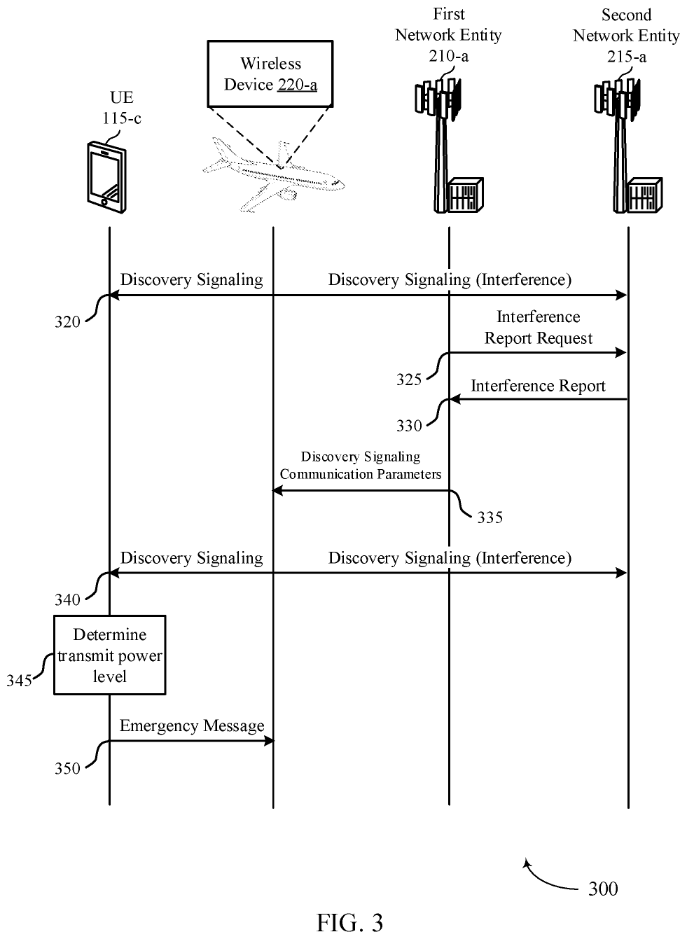

FIG. 3 illustrates an example of a process flow 300 that supports interference measurement and uplink power control enhancements for emergency message relaying in accordance with one or more aspects of the present disclosure. The process flow 300 may implement various aspects of the present disclosure described herein. The elements described in the process flow 300 may be examples of similarly-named elements described herein.

In the following description of the process flow 300, the operations between the various entities or elements may be performed in different orders or at different times. Some operations may also be left out of the process flow 300, or other operations may be added. Although the various entities or elements are shown performing the operations of the process flow 300, some aspects of some operations may also be performed by other entities or elements of the process flow 300 or by entities or elements that are not depicted in the process flow, or any combination thereof.

At 320, the wireless device 220-a may transmit broadcast emergency communications discovery signaling.

At 325, the first network entity 210-a may transmit, to the second network entity 215-a serving one or more UEs in a terrestrial network, an indication that the second network entity 215-a is to report interference with the terrestrial network caused by broadcast emergency communications discovery signaling.

At 330, the first network entity 210-a may receive, from the second network entity 215-a, a report comprising one or more indications of the interference.

At 335, the first network entity 210-a may transmit, to the wireless device 220-a, an indication of one or more discovery signaling communication parameters for transmitting the broadcast emergency communications discovery signaling based at least in part on the one or more indications of the interference. In some examples, the one or more discovery signaling communication parameters may include one or more power parameters associated with a beam-specific synchronization signal block, associated with a beam-specific reference signal, or any combination thereof.

At 340, the UE 115-c may receive, from the wireless device 220-a, broadcast emergency communications discovery signaling including one or more discovery signaling communication parameters for the UE 115-c outside a coverage area of a terrestrial communications network serving the UE 115-c.

At 345, the UE 115-c may determine a transmit power level for transmitting an emergency message based on the one or more discovery signaling communication parameters.

At 350, the UE 115-c may transmit the emergency message to the wireless device 220-a according to the determined transmit power level. In some examples, the wireless device 220-a may transmit the emergency message to the first network entity 210-a.

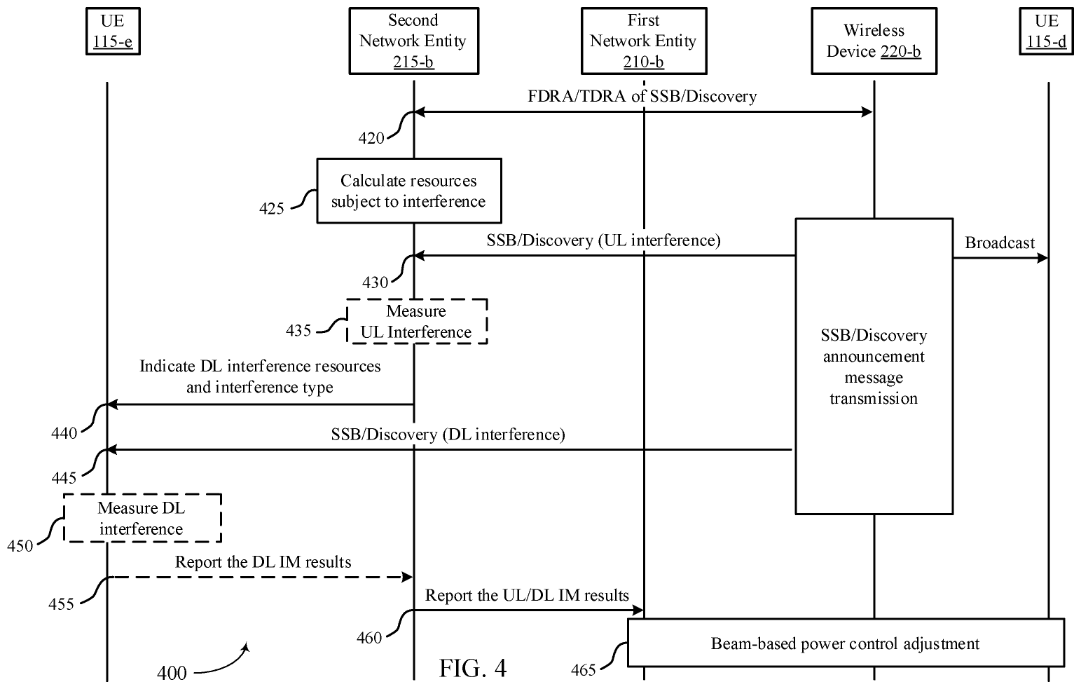

FIG. 4 illustrates an example of a process flow 400 that supports interference measurement and uplink power control enhancements for emergency message relaying in accordance with one or more aspects of the present disclosure. The process flow 400 may include or involve the UE 115-d which may be an example of UEs 115 discussed herein. In the process flow 400, the UE 115-d may be an example of a remote UE. The process flow 400 may include or involve the first network entity 210-b, which may be an example of an ATG network entity. The process flow 400 may include or involve the second network entity 215-b, which may be an example of a terrestrial network entity. The process flow 400 may include or involve the wireless device 220-b, which may be an example of a wireless device of or on an aircraft, also referred to as an airborne wireless device. The process flow 400 may include or involve the UE 115-e, which may be an example of a terrestrial UE served by the second network entity 215-b (e.g., in a terrestrial network). The process flow 400 may implement various aspects of the present disclosure described with relation to FIGS. 1-3. The elements described in the process flow 400 may be examples of similarly-named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

As described herein, the wireless device 220-b may transmit discovery signaling (e.g., an SSB or a discovery announcement message). Such a wireless device 220-b may include or be associated with a cell radius (e.g., a cell radius of 100 km or another size) and a per-beam coverage area may be larger than a per-beam coverage area in a terrestrial network or in other communications scenarios. In some examples, the wireless device 220-b may interfere with communications of a terrestrial network, such as a terrestrial network including the second network entity 215-b and the UE 115-e. Such interference may interfere with uplink communications, downlink communications, or both.

At 420, the first network entity 210-b may transmit or indicate frequency-domain resource allocation (FDRA), time-domain resource allocation (TDRA), or both, that may be associated with the transmission of the discovery signaling (e.g., an SSB or discovery announcement message). The first network entity 210-b may indicate such allocations to the wireless device 220-b, the second network entity 215-b, or both. In some examples, the first network entity 210-b may also indicate to the second network entity 215-b information about an aircraft carrying the wireless device 220-b, such as a position, velocity, heading, trajectory, altitude, other aircraft information, or any combination thereof. Any, some, or all of the previous examples of information about the aircraft may be associated with or expressed in association with global navigation satellite system (GNSS) parameters or values.

At 425, the second network entity 215-b may calculate or determine resources that may be subject to interference from the discovery signaling. For example, the second network entity 215-b may calculate, determine, or select one or more resource elements (e.g., that may include or be associated with time resources, frequency resources, spatial resources, or any combination thereof) that may be subject to the interference, and may do so based on the indications of the resource allocations (e.g., the FDRA, TDRA, or both) transmitted by the first network entity 210-b.

At 430, the wireless device 220-b may transmit the discovery signaling (e.g., an SSB or a discovery announcement message). The discovery signaling may cause interference with uplink communications at a terrestrial network (e.g., a terrestrial network involving the second network entity 215-b and the UE 115-e).

At 435 the second network entity 215-b may measure interference with uplink communications between the UE 115-e and the second network entity 215-b. For example, the second network entity 215-b may, as part of an interference management procedure or operation, measure the uplink interference at one or more resource elements that were selected, determined, or calculated based on the indications received from the first network entity 210-b.

At 440, the second network entity 215-b may transmit an indication to the UE 115-e that the UE 115-e is to measure interference with downlink communications between the second network entity 215-b and the UE 115-e. For example, the second network entity 215-b may transmit, to the UE 115-e, one or more indications of resources or resource elements that may be subject to interference, one or more types of interference, or any combination thereof.

At 445, the wireless device 220-b may transmit the discovery signaling (e.g., an SSB or a discovery announcement message). The discovery signaling may cause interference with downlink communications at a terrestrial network (e.g., a terrestrial network involving the second network entity 215-b and the UE 115-e).

At 450, the UE 115-e may measure interference with downlink communications between the UE 115-e and the second network entity 215-b. For example, the UE 115-e may, as part of an interference management procedure or operation, measure the uplink interference at one or more resource elements that were selected, determined, or calculated based on the indications received from the first network entity 210-b.

At 455, the UE 115-e may report one or more measurements, results, statistics, or other information associated with the downlink interference to the second network entity 215-b.

At 460, the second network entity 215-b may report one or more measurements, results, statistics, or other information associated with the interference (e.g., uplink, downlink, or both) caused by or associated with the discovery signaling. Such information or reporting may be transmitted to the first network entity 210-b. In some examples, the report may include the measurements, results, statistics, or other information associated with the interference that may be associated with the one or more indicated resources elements that may be subject to the interference.

At 465, the first network entity 210-b, the wireless device 220-b, the UE 115-d, or any combination thereof, may engage in one or more operations or procedures for adjustment of communications parameters (e.g., power control adjustments associated with transmission of the discovery signaling, which may be beam-based or performed, determined, selected, or calculated on a per-beam basis).

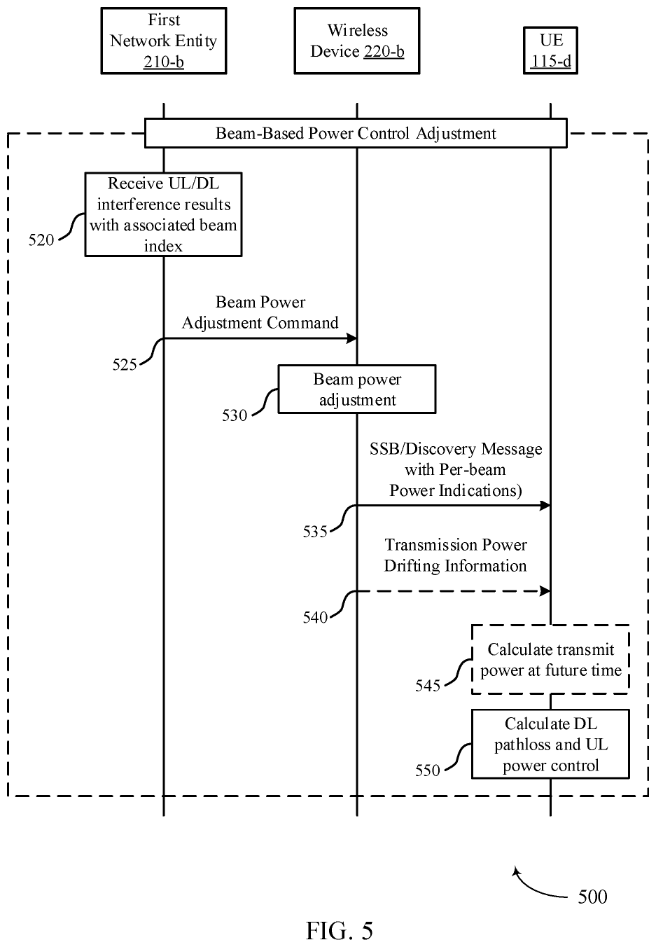

FIG. 5 illustrates an example of a process flow 500 that supports interference measurement and uplink power control enhancements for emergency message relaying in accordance with one or more aspects of the present disclosure. The process flow 500 may include or involve the UE 115-d which may be an example of UEs 115 discussed herein. In the process flow 500, the UE 115-d may be an example of a remote UE. The process flow 500 may include or involve the first network entity 210-b, which may be an example of an ATG network entity. The process flow 500 may include or involve the wireless device 220-b, which may be an example of a wireless device of or on an aircraft, also referred to as an airborne wireless device. The process flow 500 may implement various aspects of the present disclosure described herein. The elements described in the process flow 500 may be examples of similarly-named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

As depicted and described herein, the wireless device 220-b may transmit discovery signaling to discover remote UEs, such as the UE 115-d, to establish emergency or SOS communications. One or more entities or wireless devices (e.g., the wireless device 220-b, the first network entity 210-b, the UE 115-d, or any combination thereof) may perform adjustment, determination, selection, or calculation of communication parameters, which may involve beam-based power control adjustments or configurations.

As the aircraft that carries the wireless device 220-b travels, an elevation angle (a) of a direct line from the aircraft to the target beam coverage may change. For different elevation angles (α) a distance from the aircraft to the target beam coverage area may be estimated by

$$\frac{h}{sin α} .$$

For example, when a ranges from 90 degrees to 6 degrees (e.g., a target 100 km cell radius at a 10 km aircraft altitude), the pathloss distance may vary (e.g., from 10 km to 100 km), which may result in differences in pathloss values (e.g., 20 dB of pathloss) for different beam directions if the same transmission power is used for different beam directions. As such, power control enhancement operations may be performed to reduce such changes in pathloss or other communication characteristics. Further, as the distance (e.g., and pathloss values) from the wireless device 220-b to the target beam area changes dynamically, a transmission power for each beam may be adjusted accordingly. Such adjustment may be employed to reduce the interference towards terrestrial networks or keep interference with terrestrial networks at a same, similar, or relatively consistent level.

At 520, the first network entity 210-a may receive measurements, reporting, or other information associated with interference caused by the discovery signaling (e.g., at a terrestrial network) which may include measurements, reporting, or other information associated with interference with uplink communications, downlink communications, or both. In some examples, the first network entity 210-a may receive one or more indications of one or more beam indices that may be associated with the interference, the discovery signaling, or both.

At 525, the first network entity 210-b may transmit a beam power adjustment indication or command to the wireless device 220-b. In some examples, the first network entity 210-b may transmit indications of the one or more beam indices that may be associated with the beam power adjustment indication or command. For example, the indicated beam indices may indicate one or more beams whose beam power is to be adjusted to reduce interference.

At 530, the wireless device 220-b may perform beam power adjustment on one or more communication beams used for the discovery signaling. Such adjustments may be based on the indication or command transmitted by the first network entity 210-b.

At 535, the wireless device 220-b may transmit the discovery signaling (e.g., an SSB, a discovery announcement message, or any combination thereof), which may be received by the UE 115-d. In some examples, the wireless device 220-b may transmit one or more indications of transmission power used to transmit the discovery signaling (e.g., one or more indications of per-beam power). In some examples, the wireless device 220-b may transmit the one or more indications of transmission power together with or included in the discovery signaling or may transmit the one or more indications of transmission power separately from the discovery signaling.

At 540, the wireless device 220-b may transmit one or more indications of transmission power drifting information (e.g., the 3 parameter, one or more other parameters, or any combination thereof).

At 545, the UE 115-d may select, determine, or calculate a transmit power to be used for transmitting the discovery signaling. Such selection, determination, or calculation may be predictive in that it may predict or estimate a transmission power that may be used by the wireless device 220-b in the future to transmit future discovery signaling. In some examples, such selection, determination, or calculation may be based on the transmission power drifting information. For example, a transmit power (P) at time T+ΔT, where T represents a current time and ΔT represents an amount of time after the current time at which the prediction or estimation is to be made, may be expressed by P(T+ΔT)=P(T)+β·ΔT, where β is the transmission power drifting information.

At 550, the UE 115-d may determine, select, or calculate one or more pathloss values (e.g., downlink pathloss values associated with the discovery signaling or other signaling received from the wireless device 220-b), one or more power control parameters or values (e.g., uplink power control parameters, values, or both, that may be associated with transmitting an emergency or SOS message to the wireless device 220-b), or any combination thereof. In some examples, the UE 115-d may determine one or more transmit power levels for transmitting the emergency or SOS message based on the one or more pathloss values. In some examples, the UE 115-d may receive one or more indications of emergency message repetition resources. In some examples, the UE 115-d may determine transmit power levels for one or more repetitions of the emergency message based on the one or more indications of transmission power drifting information. In some examples, the UE 115-d may transmit one or more repetitions of the emergency message in accordance with the determined transmit power levels for the one or more repetition of the emergency message. In some examples, the UE 115-d may transmit one or more repetitions of the emergency message on the emergency message repetition resources.

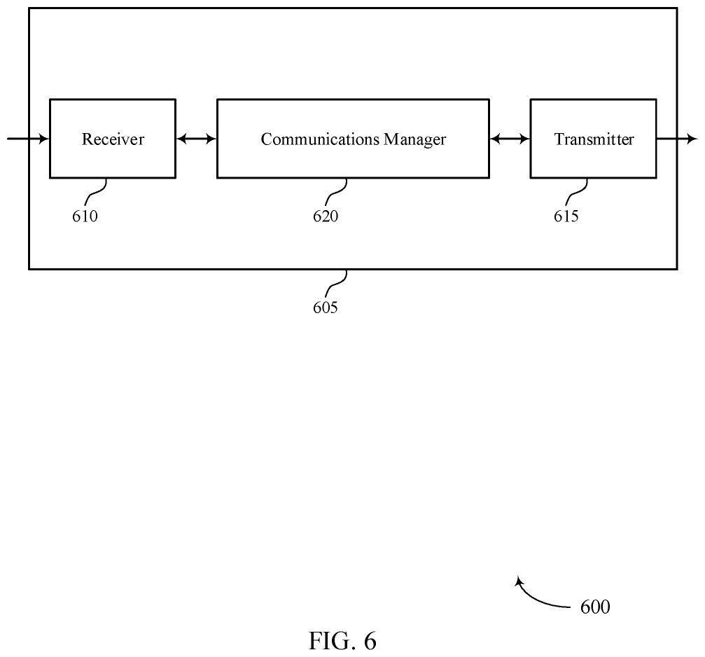

FIG. 6 shows a block diagram 600 of a device 605 that supports interference measurement and uplink power control enhancements for emergency message relaying in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to interference measurement and uplink power control enhancements for emergency message relaying). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to interference measurement and uplink power control enhancements for emergency message relaying). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of interference measurement and uplink power control enhancements for emergency message relaying as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first UE in accordance with examples as disclosed herein. For example, the communications manager 620 may be configured as or otherwise support a means for receiving, from a wireless device of an aircraft, broadcast emergency communications discovery signaling including one or more discovery signaling communication parameters for the UE outside a coverage area of a terrestrial communications network serving the UE. The communications manager 620 may be configured as or otherwise support a means for determining a transmit power level for transmitting an emergency message based on the one or more discovery signaling communication parameters. The communications manager 620 may be configured as or otherwise support a means for transmitting the emergency message to the wireless device of the aircraft according to the determined transmit power level.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, more efficient utilization of communication resources, or any combination thereof.

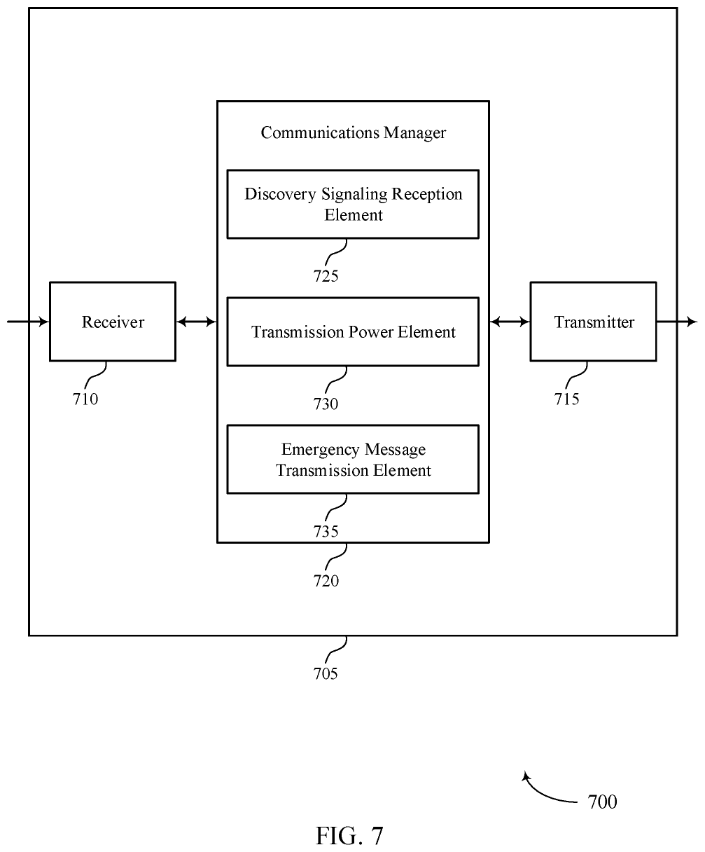

FIG. 7 shows a block diagram 700 of a device 705 that supports interference measurement and uplink power control enhancements for emergency message relaying in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to interference measurement and uplink power control enhancements for emergency message relaying). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to interference measurement and uplink power control enhancements for emergency message relaying). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of interference measurement and uplink power control enhancements for emergency message relaying as described herein. For example, the communications manager 720 may include a discovery signaling reception element 725, a transmission power element 730, an emergency message transmission element 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE in accordance with examples as disclosed herein. The discovery signaling reception element 725 may be configured as or otherwise support a means for receiving, from a wireless device of an aircraft, broadcast emergency communications discovery signaling including one or more discovery signaling communication parameters for the UE outside a coverage area of a terrestrial communications network serving the UE. The transmission power element 730 may be configured as or otherwise support a means for determining a transmit power level for transmitting an emergency message based on the one or more discovery signaling communication parameters. The emergency message transmission element 735 may be configured as or otherwise support a means for transmitting the emergency message to the wireless device of the aircraft according to the determined transmit power level.

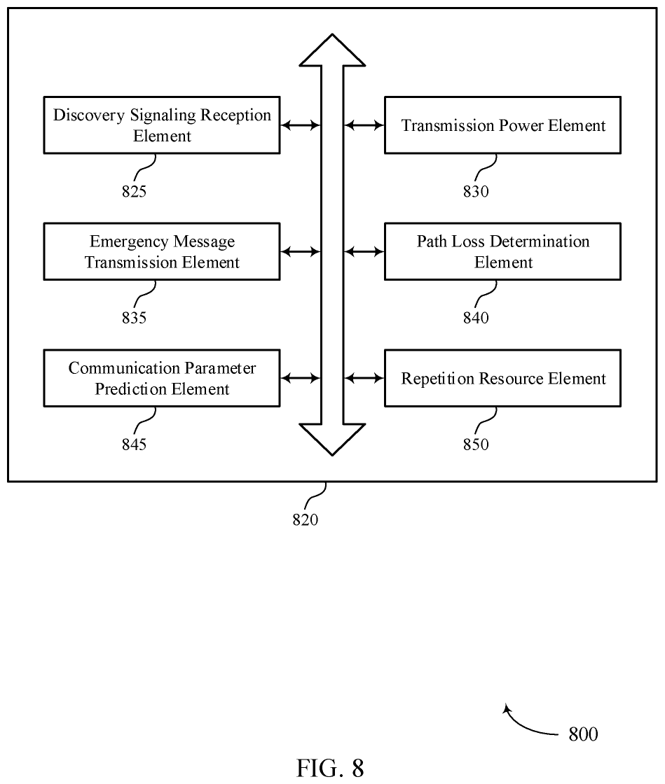

FIG. 8 shows a block diagram 800 of a communications manager 820 that supports interference measurement and uplink power control enhancements for emergency message relaying in accordance with one or more aspects of the present disclosure. The communications manager 820 may be an example of aspects of a communications manager 620, a communications manager 720, or both, as described herein. The communications manager 820, or various components thereof, may be an example of means for performing various aspects of interference measurement and uplink power control enhancements for emergency message relaying as described herein. For example, the communications manager 820 may include a discovery signaling reception element 825, a transmission power element 830, an emergency message transmission element 835, a path loss determination element 840, a communication parameter prediction element 845, a repetition resource element 850, or any combination thereof. Each of these components may communicate, directly or indirectly, with one another (e.g., via one or more buses).

The communications manager 820 may support wireless communication at a first UE in accordance with examples as disclosed herein. The discovery signaling reception element 825 may be configured as or otherwise support a means for receiving, from a wireless device of an aircraft, broadcast emergency communications discovery signaling including one or more discovery signaling communication parameters for the UE outside a coverage area of a terrestrial communications network serving the UE. The transmission power element 830 may be configured as or otherwise support a means for determining a transmit power level for transmitting an emergency message based on the one or more discovery signaling communication parameters. The emergency message transmission element 835 may be configured as or otherwise support a means for transmitting the emergency message to the wireless device of the aircraft according to the determined transmit power level.

In some examples, the path loss determination element 840 may be configured as or otherwise support a means for determining one or more path loss values associated with the broadcast emergency communications discovery signaling based on the one or more discovery signaling communication parameters. In some examples, the transmission power element 830 may be configured as or otherwise support a means for determining the transmit power level based on the one or more path loss values.

In some examples, the discovery signaling reception element 825 may be configured as or otherwise support a means for receiving the one or more discovery signaling communication parameters including one or more power parameters associated with a beam-specific synchronization signal block, associated with a beam-specific reference signal, or any combination thereof. In some examples, the transmission power element 830 may be configured as or otherwise support a means for determining the transmit power level based on the one or more power parameters.

In some examples, the discovery signaling reception element 825 may be configured as or otherwise support a means for receiving the one or more discovery signaling communication parameters including one or more indications of transmission power drifting information. In some examples, the communication parameter prediction element 845 may be configured as or otherwise support a means for determining one or more predictive discovery signaling communication parameters based on the one or more indications of transmission power drifting information. In some examples, the transmission power element 830 may be configured as or otherwise support a means for determining the transmit power level based on the one or more predictive discovery signaling communication parameters.

In some examples, the transmission power element 830 may be configured as or otherwise support a means for determining transmit power levels for one or more repetitions of the emergency message based on the one or more indications of transmission power drifting information. In some examples, the emergency message transmission element 835 may be configured as or otherwise support a means for transmitting the one or more repetitions in accordance with the determined transmit power levels for the one or more repetitions of the emergency message.

In some examples, the repetition resource element 850 may be configured as or otherwise support a means for receiving one or more indications of emergency message repetition resources. In some examples, the emergency message transmission element 835 may be configured as or otherwise support a means for transmitting one or more repetitions of the emergency message on the emergency message repetition resources.

In some examples, the UE is outside any coverage area of any terrestrial communications network.

In some examples, the broadcast emergency communications discovery signaling includes a synchronization signal block or an announcement message.

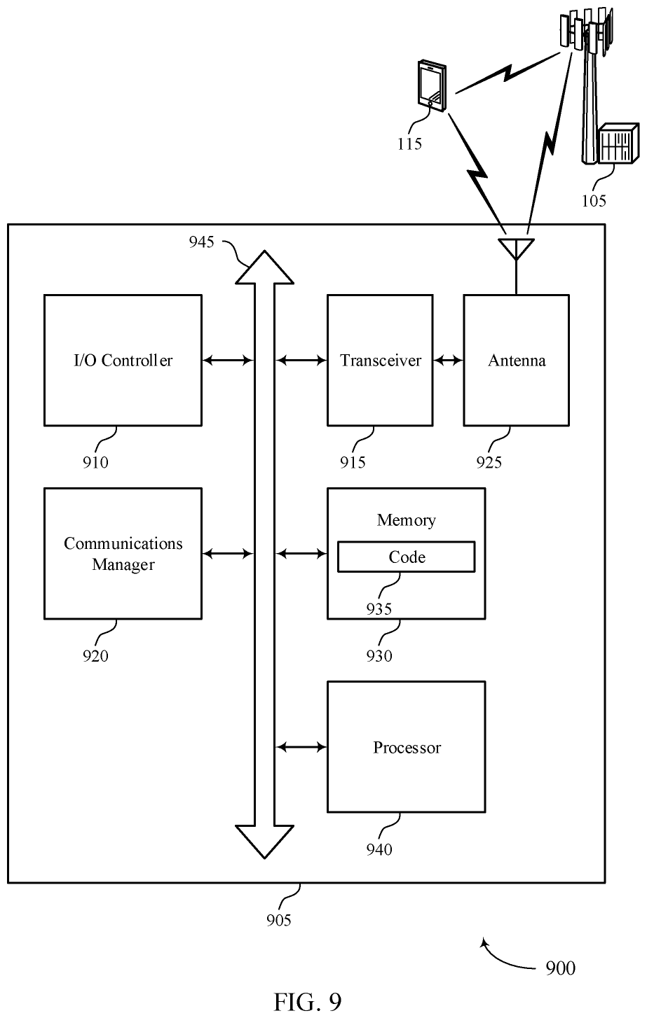

FIG. 9 shows a diagram of a system 900 including a device 905 that supports interference measurement and uplink power control enhancements for emergency message relaying in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting interference measurement and uplink power control enhancements for emergency message relaying). For example, the device 905 or a component of the device 905 may include a processor 940 and memory 930 coupled with or to the processor 940, the processor 940 and memory 930 configured to perform various functions described herein.

The communications manager 920 may support wireless communication at a first UE in accordance with examples as disclosed herein. For example, the communications manager 920 may be configured as or otherwise support a means for receiving, from a wireless device of an aircraft, broadcast emergency communications discovery signaling including one or more discovery signaling communication parameters for the UE outside a coverage area of a terrestrial communications network serving the UE. The communications manager 920 may be configured as or otherwise support a means for determining a transmit power level for transmitting an emergency message based on the one or more discovery signaling communication parameters. The communications manager 920 may be configured as or otherwise support a means for transmitting the emergency message to the wireless device of the aircraft according to the determined transmit power level.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of interference measurement and uplink power control enhancements for emergency message relaying as described herein, or the processor 940 and the memory 930 may be otherwise configured to perform or support such operations.

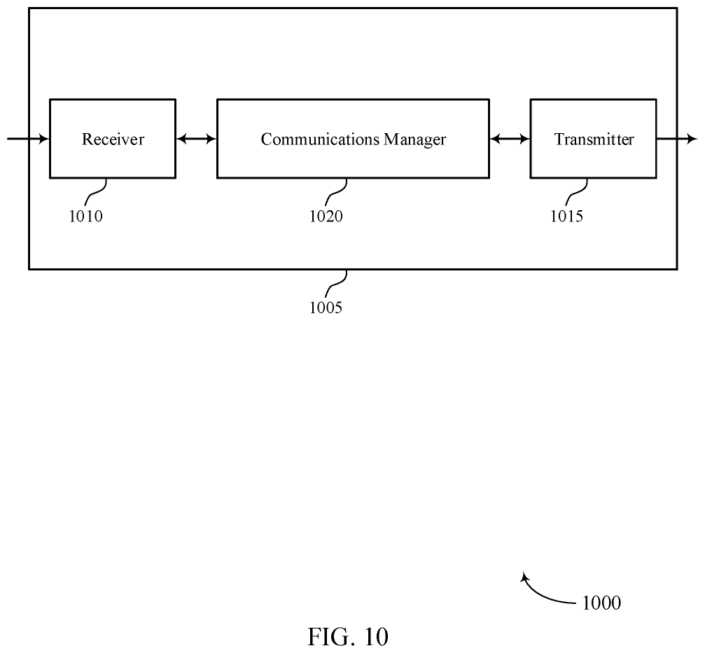

FIG. 10 shows a block diagram 1000 of a device 1005 that supports interference measurement and uplink power control enhancements for emergency message relaying in accordance with one or more aspects of the present disclosure. The device 1005 may be an example of aspects of a wireless device as described herein. Though the device 1005 is described as including various components or elements, the device 1005 may also include components or elements described in connection with other devices (e.g., the device 605, the device 705, the device 905, the device 1105, the device 1305, the device 1405, the device 1505, the device 1705, or any combination thereof). The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to interference measurement and uplink power control enhancements for emergency message relaying). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to interference measurement and uplink power control enhancements for emergency message relaying). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of interference measurement and uplink power control enhancements for emergency message relaying as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a wireless device of an aircraft in accordance with examples as disclosed herein. For example, the communications manager 1020 may be configured as or otherwise support a means for transmitting a first emergency communications discovery signal. The communications manager 1020 may be configured as or otherwise support a means for receiving, from a first network entity, an indication of one or more discovery signaling communication parameters. The communications manager 1020 may be configured as or otherwise support a means for transmitting a second emergency communications discovery signal for establishing communications with a UE in accordance with the indication of the one or more discovery signaling communication parameters. The communications manager 1020 may be configured as or otherwise support a means for transmitting, to the UE, power control parameters associated with transmitting the second emergency communications discovery signal.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, more efficient utilization of communication resources, or any combination thereof.

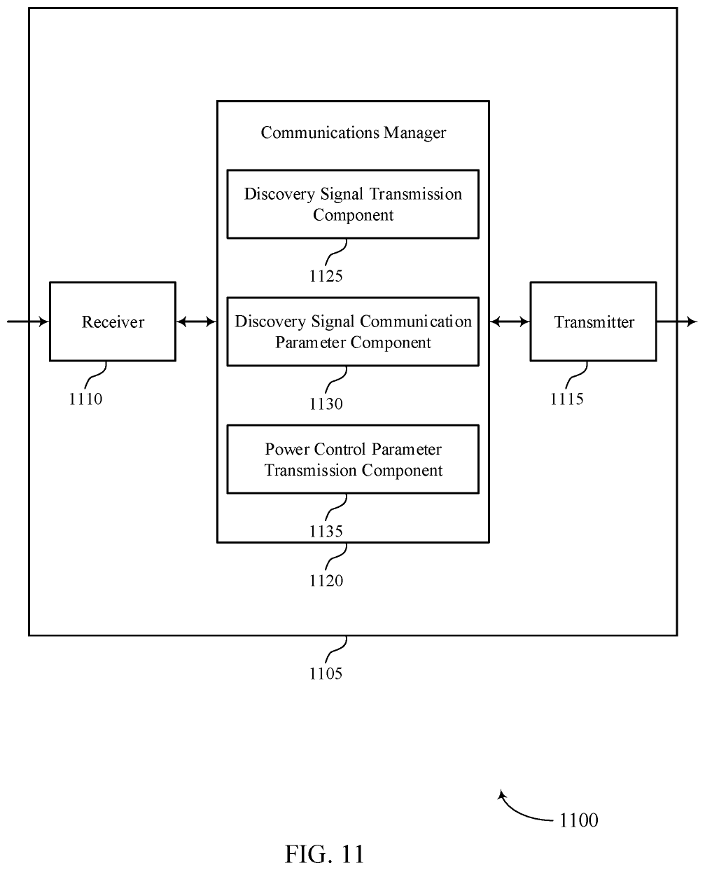

FIG. 11 shows a block diagram 1100 of a device 1105 that supports interference measurement and uplink power control enhancements for emergency message relaying in accordance with one or more aspects of the present disclosure. The device 1105 may be an example of aspects of a device 1005 or a wireless device 1105 as described herein. Though the device 1105 is described as including various components or elements, the device 1105 may also include components or elements described in connection with other devices (e.g., the device 605, the device 705, the device 905, the device 1005, the device 1305, the device 1405, the device 1505, the device 1705, or any combination thereof). The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to interference measurement and uplink power control enhancements for emergency message relaying). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to interference measurement and uplink power control enhancements for emergency message relaying). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of interference measurement and uplink power control enhancements for emergency message relaying as described herein. For example, the communications manager 1120 may include a discovery signal transmission component 1125, a discovery signal communication parameter component 1130, a power control parameter transmission component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a wireless device of an aircraft in accordance with examples as disclosed herein. The discovery signal transmission component 1125 may be configured as or otherwise support a means for transmitting a first emergency communications discovery signal. The discovery signal communication parameter component 1130 may be configured as or otherwise support a means for receiving, from a first network entity, an indication of one or more discovery signaling communication parameters. The discovery signal transmission component 1125 may be configured as or otherwise support a means for transmitting a second emergency communications discovery signal for establishing communications with a UE in accordance with the indication of the one or more discovery signaling communication parameters. The power control parameter transmission component 1135 may be configured as or otherwise support a means for transmitting, to the UE, power control parameters associated with transmitting the second emergency communications discovery signal.

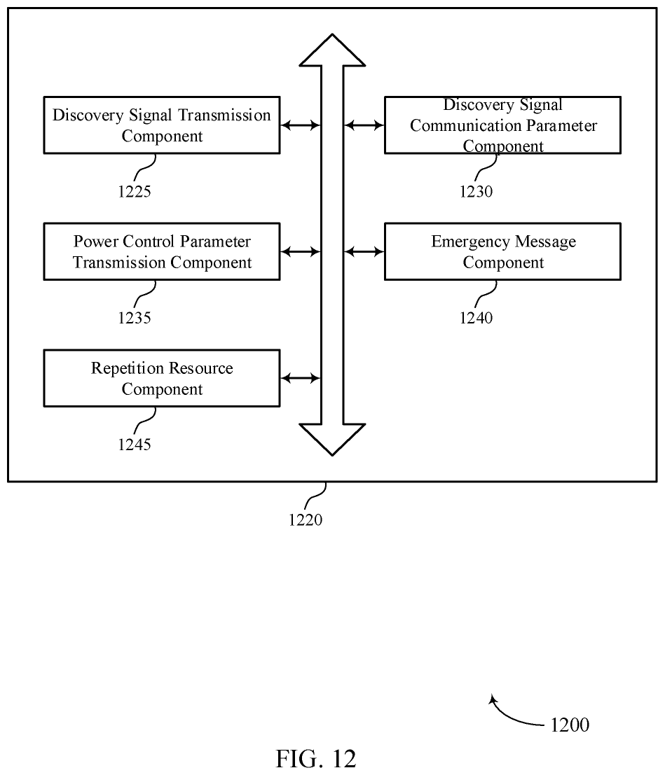

FIG. 12 shows a block diagram 1200 of a communications manager 1220 that supports interference measurement and uplink power control enhancements for emergency message relaying in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of interference measurement and uplink power control enhancements for emergency message relaying as described herein. For example, the communications manager 1220 may include a discovery signal transmission component 1225, a discovery signal communication parameter component 1230, a power control parameter transmission component 1235, an emergency message component 1240, a repetition resource component 1245, or any combination thereof. Each of these components may communicate, directly or indirectly, with one another (e.g., via one or more buses).

The communications manager 1220 may support wireless communication at a wireless device of an aircraft in accordance with examples as disclosed herein. The discovery signal transmission component 1225 may be configured as or otherwise support a means for transmitting a first emergency communications discovery signal. The discovery signal communication parameter component 1230 may be configured as or otherwise support a means for receiving, from a first network entity, an indication of one or more discovery signaling communication parameters. In some examples, the discovery signal transmission component 1225 may be configured as or otherwise support a means for transmitting a second emergency communications discovery signal for establishing communications with a UE in accordance with the indication of the one or more discovery signaling communication parameters. The power control parameter transmission component 1235 may be configured as or otherwise support a means for transmitting, to the UE, power control parameters associated with transmitting the second emergency communications discovery signal.

In some examples, the power control parameter transmission component 1235 may be configured as or otherwise support a means for transmitting, to the UE, the power control parameters including one or more power parameters associated with a beam-specific synchronization signal block, associated with a beam-specific reference signal, or any combination thereof.

In some examples, the power control parameter transmission component 1235 may be configured as or otherwise support a means for transmitting, to the UE, the power control parameters including one or more indications of transmission power drifting information.

In some examples, the emergency message component 1240 may be configured as or otherwise support a means for receiving an emergency message from the UE. In some examples, the emergency message component 1240 may be configured as or otherwise support a means for transmitting the emergency message to the first network entity.

In some examples, the repetition resource component 1245 may be configured as or otherwise support a means for transmitting, to the UE, one or more indications of emergency message repetition resources. In some examples, the emergency message component 1240 may be configured as or otherwise support a means for receiving one or more repetitions of an emergency message on the emergency message repetition resources.

In some examples, the first emergency communications discovery signal and the second emergency communications discovery signal each include a synchronization signal block or an announcement message.

In some examples, the wireless device of the aircraft operates as a base station or a UE.

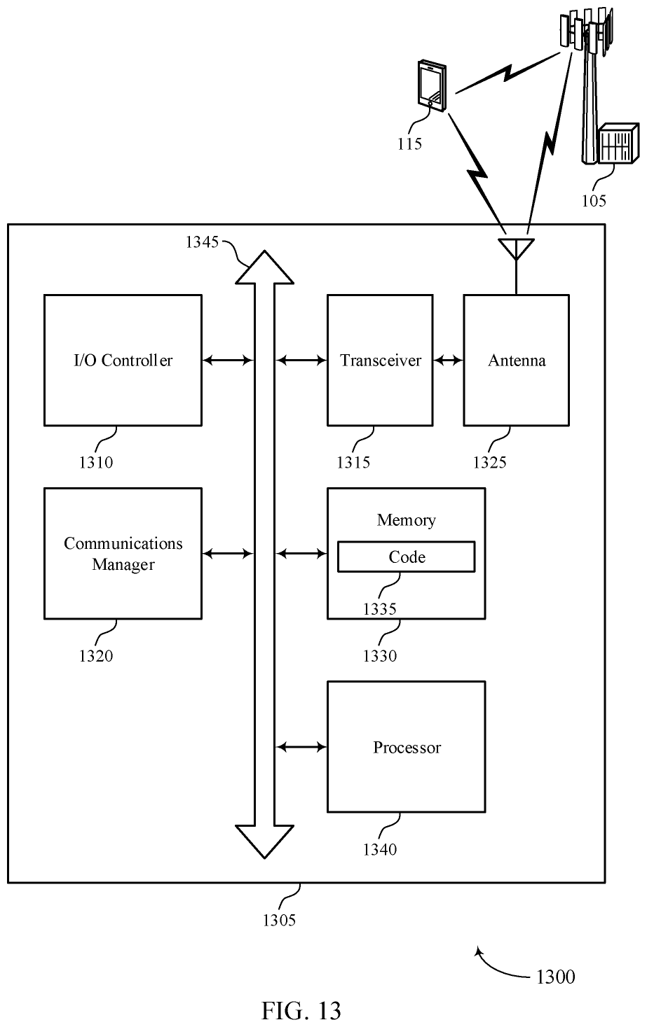

FIG. 13 shows a diagram of a system 1300 including a device 1305 that supports interference measurement and uplink power control enhancements for emergency message relaying in accordance with one or more aspects of the present disclosure. The device 1305 may be an example of or include the components of a device 1005, a device 1105, or a wireless device as described herein. Though the device 1305 is described as including various components or elements, the device 1305 may also include components or elements described in connection with other devices (e.g., the device 605, the device 705, the device 905, the device 1005, the device 1005, the device 1105, the device 1405, the device 1505, the device 1705, or any combination thereof). The device 1305 may include components for bi-directional voice and data communications including components for transmitting and receiving communications, such as a communications manager 1320, an I/O controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting interference measurement and uplink power control enhancements for emergency message relaying). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communication at a wireless device of an aircraft in accordance with examples as disclosed herein. For example, the communications manager 1320 may be configured as or otherwise support a means for transmitting a first emergency communications discovery signal. The communications manager 1320 may be configured as or otherwise support a means for receiving, from a first network entity, an indication of one or more discovery signaling communication parameters. The communications manager 1320 may be configured as or otherwise support a means for transmitting a second emergency communications discovery signal for establishing communications with a UE in accordance with the indication of the one or more discovery signaling communication parameters. The communications manager 1320 may be configured as or otherwise support a means for transmitting, to the UE, power control parameters associated with transmitting the second emergency communications discovery signal.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of interference measurement and uplink power control enhancements for emergency message relaying as described herein, or the processor 1340 and the memory 1330 may be otherwise configured to perform or support such operations.

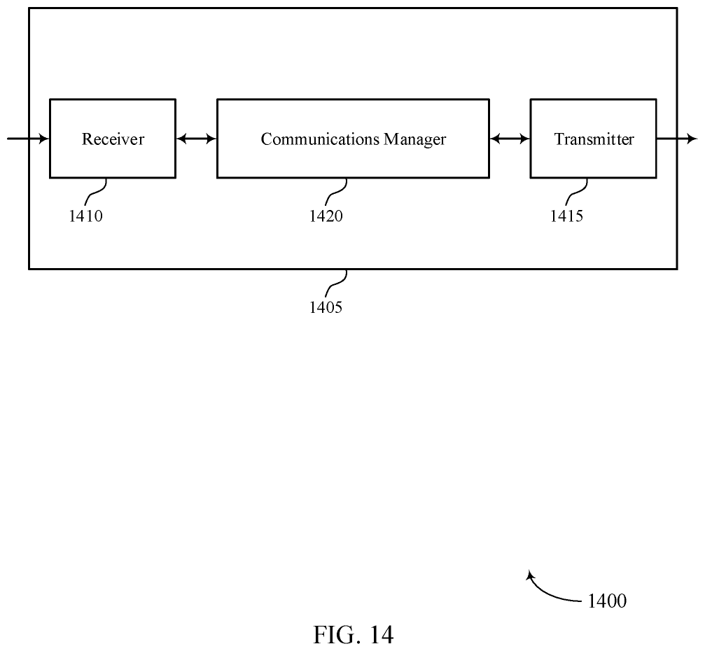

FIG. 14 shows a block diagram 1400 of a device 1405 that supports interference measurement and uplink power control enhancements for emergency message relaying in accordance with one or more aspects of the present disclosure. The device 1405 may be an example of aspects of a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations thereof or various components thereof may be examples of means for performing various aspects of interference measurement and uplink power control enhancements for emergency message relaying as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1420, the receiver 1410, the transmitter 1415, or various combinations or components thereof may be implemented in code (e.g., as communications management software or firmware) executed by a processor. If implemented in code executed by a processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a first network entity that serves a wireless device of an aircraft in accordance with examples as disclosed herein. For example, the communications manager 1420 may be configured as or otherwise support a means for transmitting, to a second network entity serving one or more UEs in a terrestrial network, an indication that the second network entity is to report interference with the terrestrial network caused by broadcast emergency communications discovery signaling. The communications manager 1420 may be configured as or otherwise support a means for receiving, from the second network entity, a report including one or more indications of the interference. The communications manager 1420 may be configured as or otherwise support a means for transmitting, to the wireless device of the aircraft, an indication of one or more discovery signaling communication parameters for transmitting the broadcast emergency communications discovery signaling based on the one or more indications of the interference.

Additionally, or alternatively, the communications manager 1420 may support wireless communication at a second network entity serving one or more UEs in a terrestrial network in accordance with examples as disclosed herein. For example, the communications manager 1420 may be configured as or otherwise support a means for receiving, from a wireless device of an aircraft, broadcast emergency communications discovery signaling that causes interference with communications in the terrestrial network. The communications manager 1420 may be configured as or otherwise support a means for receiving, from a first network entity that serves the wireless device of the aircraft, an indication that the second network entity is to report one or more indications of the interference. The communications manager 1420 may be configured as or otherwise support a means for transmitting, to the first network entity, a report including the one or more indications of the interference.

By including or configuring the communications manager 1420 in accordance with examples as described herein, the device 1405 (e.g., a processor controlling or otherwise coupled with the receiver 1410, the transmitter 1415, the communications manager 1420, or a combination thereof) may support techniques for reduced processing, reduced power consumption, more efficient utilization of communication resources, or any combination thereof.

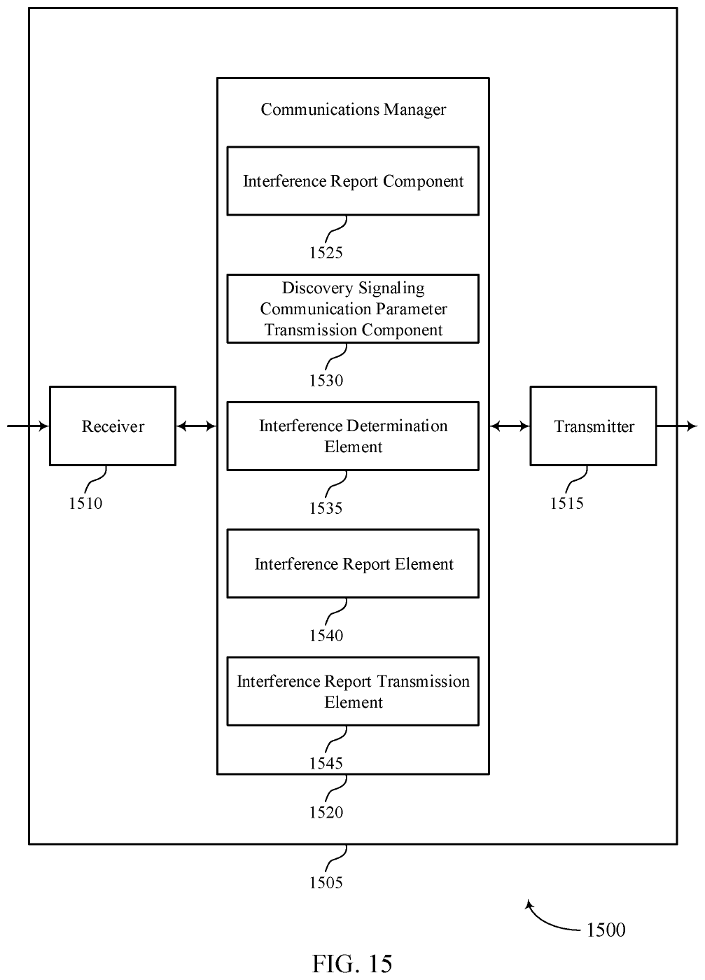

FIG. 15 shows a block diagram 1500 of a device 1505 that supports interference measurement and uplink power control enhancements for emergency message relaying in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of interference measurement and uplink power control enhancements for emergency message relaying as described herein. For example, the communications manager 1520 may include an interference report component 1525, a discovery signaling communication parameter transmission component 1530, an interference determination element 1535, an interference report element 1540, an interference report transmission element 1545, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communication at a first network entity that serves a wireless device of an aircraft in accordance with examples as disclosed herein. The interference report component 1525 may be configured as or otherwise support a means for transmitting, to a second network entity serving one or more UEs in a terrestrial network, an indication that the second network entity is to report interference with the terrestrial network caused by broadcast emergency communications discovery signaling. The interference report component 1525 may be configured as or otherwise support a means for receiving, from the second network entity, a report including one or more indications of the interference. The discovery signaling communication parameter transmission component 1530 may be configured as or otherwise support a means for transmitting, to the wireless device of the aircraft, an indication of one or more discovery signaling communication parameters for transmitting the broadcast emergency communications discovery signaling based on the one or more indications of the interference.

Additionally, or alternatively, the communications manager 1520 may support wireless communication at a second network entity serving one or moreUEs in a terrestrial network in accordance with examples as disclosed herein. The interference determination element 1535 may be configured as or otherwise support a means for receiving, from a wireless device of an aircraft, broadcast emergency communications discovery signaling that causes interference with communications in the terrestrial network. The interference report element 1540 may be configured as or otherwise support a means for receiving, from a first network entity that serves the wireless device of the aircraft, an indication that the second network entity is to report one or more indications of the interference. The interference report transmission element 1545 may be configured as or otherwise support a means for transmitting, to the first network entity, a report including the one or more indications of the interference.

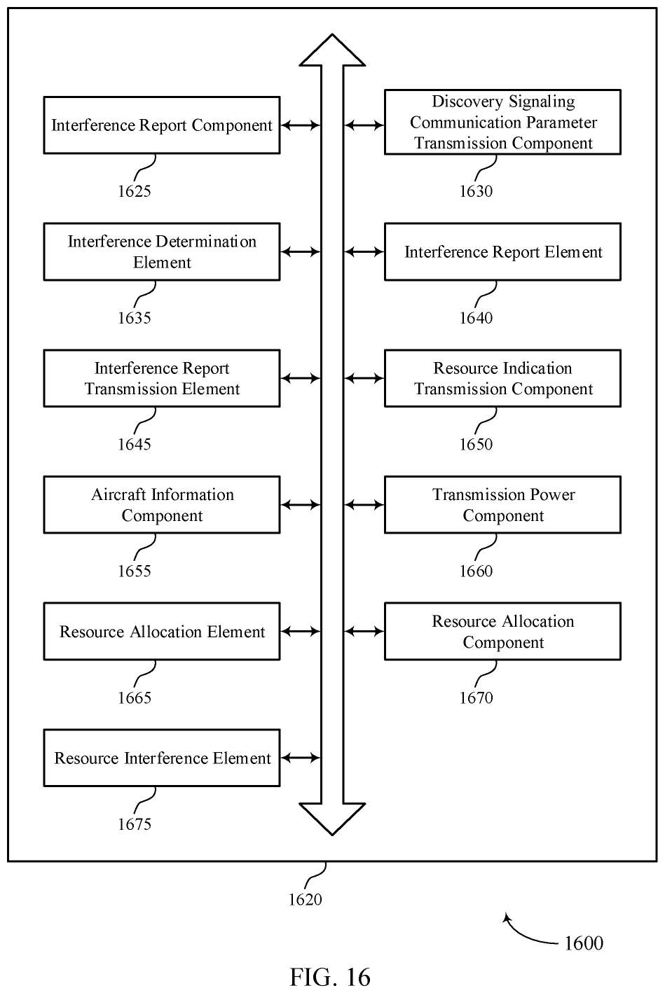

FIG. 16 shows a block diagram 1600 of a communications manager 1620 that supports interference measurement and uplink power control enhancements for emergency message relaying in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of interference measurement and uplink power control enhancements for emergency message relaying as described herein. For example, the communications manager 1620 may include an interference report component 1625, a discovery signaling communication parameter transmission component 1630, an interference determination element 1635, an interference report element 1640, an interference report transmission element 1645, a resource indication transmission component 1650, an aircraft information component 1655, a transmission power component 1660, a resource allocation element 1665, a resource allocation component 1670, a resource interference element 1675, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1620 may support wireless communication at a first network entity that serves a wireless device of an aircraft in accordance with examples as disclosed herein. The interference report component 1625 may be configured as or otherwise support a means for transmitting, to a second network entity serving one or more UEs in a terrestrial network, an indication that the second network entity is to report interference with the terrestrial network caused by broadcast emergency communications discovery signaling. In some examples, the interference report component 1625 may be configured as or otherwise support a means for receiving, from the second network entity, a report including one or more indications of the interference. The discovery signaling communication parameter transmission component 1630 may be configured as or otherwise support a means for transmitting, to the wireless device of the aircraft, an indication of one or more discovery signaling communication parameters for transmitting the broadcast emergency communications discovery signaling based on the one or more indications of the interference.

In some examples, the resource indication transmission component 1650 may be configured as or otherwise support a means for transmitting, to the second network entity, the wireless device of the aircraft, or both, one or more indications of resource allocation associated with the broadcast emergency communications discovery signaling.

In some examples, the resource allocation component 1670 may be configured as or otherwise support a means for determining the one or more indications of resource allocation based on a location of the aircraft, a trajectory of the aircraft, information associated with the aircraft, or any combination thereof.

In some examples, the aircraft information component 1655 may be configured as or otherwise support a means for transmitting, to the second network entity, a position of the aircraft, a trajectory of the aircraft, or both.

In some examples, the transmission power component 1660 may be configured as or otherwise support a means for selecting one or more transmission power parameters based on the one or more indications of the interference. In some examples, the transmission power component 1660 may be configured as or otherwise support a means for transmitting, to the wireless device of the aircraft, an indication of the one or more transmission power parameters.

In some examples, the interference report component 1625 may be configured as or otherwise support a means for receiving the report including one or more beam indices associated with the interference. In some examples, the interference report component 1625 may be configured as or otherwise support a means for transmitting, to the wireless device of the aircraft, an indication of the one or more beam indices.

In some examples, the broadcast emergency communications discovery signaling includes a synchronization signal block or an announcement message.

Additionally, or alternatively, the communications manager 1620 may support wireless communication at a second network entity serving one or more UEs in a terrestrial network in accordance with examples as disclosed herein. The interference determination element 1635 may be configured as or otherwise support a means for receiving, from a wireless device of an aircraft, broadcast emergency communications discovery signaling that causes interference with communications in the terrestrial network. The interference report element 1640 may be configured as or otherwise support a means for receiving, from a first network entity that serves the wireless device of the aircraft, an indication that the second network entity is to report one or more indications of the interference. The interference report transmission element 1645 may be configured as or otherwise support a means for transmitting, to the first network entity, a report including the one or more indications of the interference.

In some examples, the interference report transmission element 1645 may be configured as or otherwise support a means for transmitting, to the first network entity, the report including one or more indications of downlink interference measured at the one or more UEs.

In some examples, the resource interference element 1675 may be configured as or otherwise support a means for transmitting, to the one or more UEs, an indication of one or more resources that are subject to the interference.

In some examples, the interference determination element 1635 may be configured as or otherwise support a means for transmitting, to the first network entity, the report including one or more indications of uplink interference measured at the second network entity.

In some examples, the interference report transmission element 1645 may be configured as or otherwise support a means for transmitting, to the first network entity, the report including one or more indications of beam indices associated with the broadcast emergency communications discovery signaling.

In some examples, the resource allocation element 1665 may be configured as or otherwise support a means for receiving one or more indications of resource allocation associated with the broadcast emergency communications discovery signaling.

In some examples, the interference determination element 1635 may be configured as or otherwise support a means for determining one or more resource elements subject to the interference based on the one or more indications of resource allocation. In some examples, the interference report transmission element 1645 may be configured as or otherwise support a means for transmitting the report including the one or more indications of interference associated with the one or more resource elements.

In some examples, the interference determination element 1635 may be configured as or otherwise support a means for where the broadcast emergency communications discovery signaling includes a synchronization signal block or an announcement message.

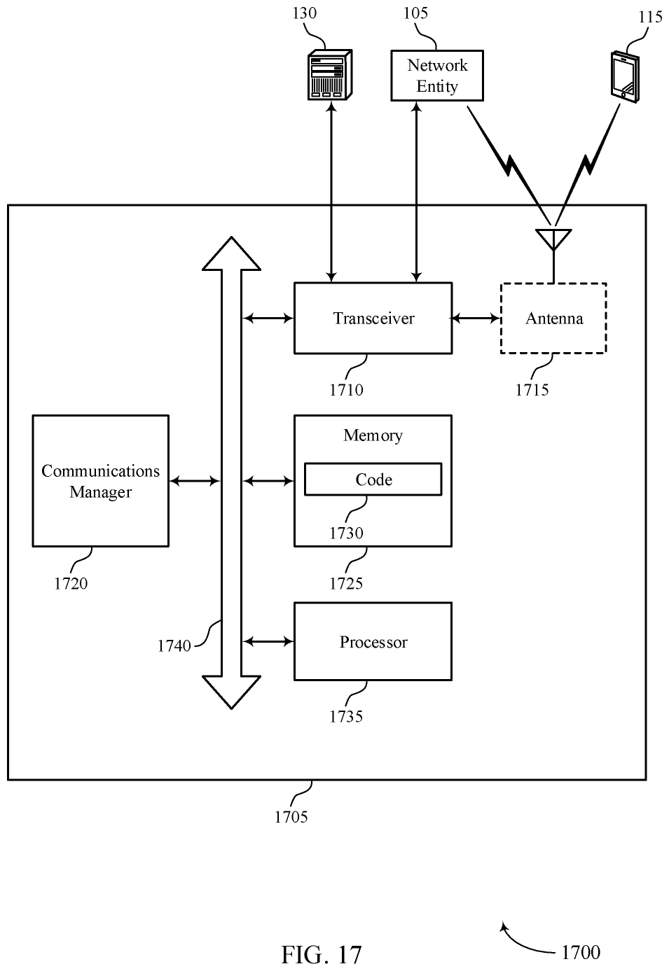

FIG. 17 shows a diagram of a system 1700 including a device 1705 that supports interference measurement and uplink power control enhancements for emergency message relaying in accordance with one or more aspects of the present disclosure. The device 1705 may be an example of or include the components of a device 1405, a device 1505, or a network entity 105 as described herein. The device 1705 may communicate with one or more network entities 105, one or more UEs 115, or any combination thereof, which may include communications over one or more wired interfaces, over one or more wireless interfaces, or any combination thereof. The device 1705 may include components that support outputting and obtaining communications, such as a communications manager 1720, a transceiver 1710, an antenna 1715, a memory 1725, code 1730, and a processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. The transceiver 1710, or the transceiver 1710 and one or more antennas 1715 or wired interfaces, where applicable, may be an example of a transmitter 1415, a transmitter 1515, a receiver 1410, a receiver 1510, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1725 may include RAM and ROM. The memory 1725 may store computer-readable, computer-executable code 1730 including instructions that, when executed by the processor 1735, cause the device 1705 to perform various functions described herein. The code 1730 may be stored in a non-transitory computer-readable medium such as system memory or another type of memory. In some cases, the code 1730 may not be directly executable by the processor 1735 but may cause a computer (e.g., when compiled and executed) to perform functions described herein. In some cases, the memory 1725 may contain, among other things, a BIOS which may control basic hardware or software operation such as the interaction with peripheral components or devices.

The processor 1735 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1735 may be configured to operate a memory array using a memory controller. In some other cases, a memory controller may be integrated into the processor 1735. The processor 1735 may be configured to execute computer-readable instructions stored in a memory (e.g., the memory 1725) to cause the device 1705 to perform various functions (e.g., functions or tasks supporting interference measurement and uplink power control enhancements for emergency message relaying). For example, the device 1705 or a component of the device 1705 may include a processor 1735 and memory 1725 coupled with the processor 1735, the processor 1735 and memory 1725 configured to perform various functions described herein. The processor 1735 may be an example of a cloud-computing platform (e.g., one or more physical nodes and supporting software such as operating systems, virtual machines, or container instances) that may host the functions (e.g., by executing code 1730) to perform the functions of the device 1705.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the memory 1725, the code 1730, and the processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with other network entities 105, and may include a controller or scheduler for controlling communications with UEs 115 in cooperation with other network entities 105. In some examples, the communications manager 1720 may support an X2 interface within an LTE/LTE-A wireless communications network technology to provide communication between network entities 105.

The communications manager 1720 may support wireless communication at a first network entity that serves a wireless device of an aircraft in accordance with examples as disclosed herein. For example, the communications manager 1720 may be configured as or otherwise support a means for transmitting, to a second network entity serving one or more UEs in a terrestrial network, an indication that the second network entity is to report interference with the terrestrial network caused by broadcast emergency communications discovery signaling. The communications manager 1720 may be configured as or otherwise support a means for receiving, from the second network entity, a report including one or more indications of the interference. The communications manager 1720 may be configured as or otherwise support a means for transmitting, to the wireless device of the aircraft, an indication of one or more discovery signaling communication parameters for transmitting the broadcast emergency communications discovery signaling based on the one or more indications of the interference.

Additionally, or alternatively, the communications manager 1720 may support wireless communication at a second network entity serving one or more UEsin a terrestrial network in accordance with examples as disclosed herein. For example, the communications manager 1720 may be configured as or otherwise support a means for receiving, from a wireless device of an aircraft, broadcast emergency communications discovery signaling that causes interference with communications in the terrestrial network. The communications manager 1720 may be configured as or otherwise support a means for receiving, from a first network entity that serves the wireless device of the aircraft, an indication that the second network entity is to report one or more indications of the interference. The communications manager 1720 may be configured as or otherwise support a means for transmitting, to the first network entity, a report including the one or more indications of the interference.

By including or configuring the communications manager 1720 in accordance with examples as described herein, the device 1705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the processor 1735, the memory 1725, the code 1730, the transceiver 1710, or any combination thereof. For example, the code 1730 may include instructions executable by the processor 1735 to cause the device 1705 to perform various aspects of interference measurement and uplink power control enhancements for emergency message relaying as described herein, or the processor 1735 and the memory 1725 may be otherwise configured to perform or support such operations.

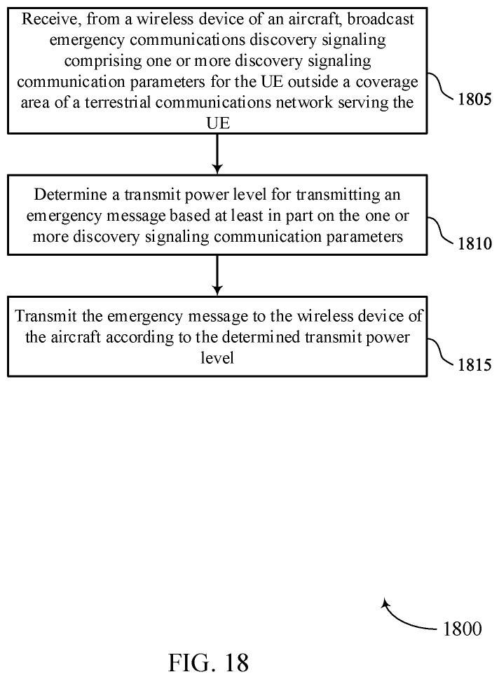

FIG. 18 shows a flowchart illustrating a method 1800 that supports interference measurement and uplink power control enhancements for emergency message relaying in accordance with one or more aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1805, the method may include receiving, from a wireless device of an aircraft, broadcast emergency communications discovery signaling including one or more discovery signaling communication parameters for the UE outside a coverage area of a terrestrial communications network serving the UE. The operations of 1805 may be performed in accordance with examples as disclosed herein. In some examples, aspects of the operations of 1805 may be performed by a discovery signaling reception element 825 as described with reference to FIG. 8.

At 1810, the method may include determining a transmit power level for transmitting an emergency message based on the one or more discovery signaling communication parameters. The operations of 1810 may be performed in accordance with examples as disclosed herein. In some examples, aspects of the operations of 1810 may be performed by a transmission power element 830 as described with reference to FIG. 8.

At 1815, the method may include transmitting the emergency message to the wireless device of the aircraft according to the determined transmit power level. The operations of 1815 may be performed in accordance with examples as disclosed herein. In some examples, aspects of the operations of 1815 may be performed by an emergency message transmission element 835 as described with reference to FIG. 8.

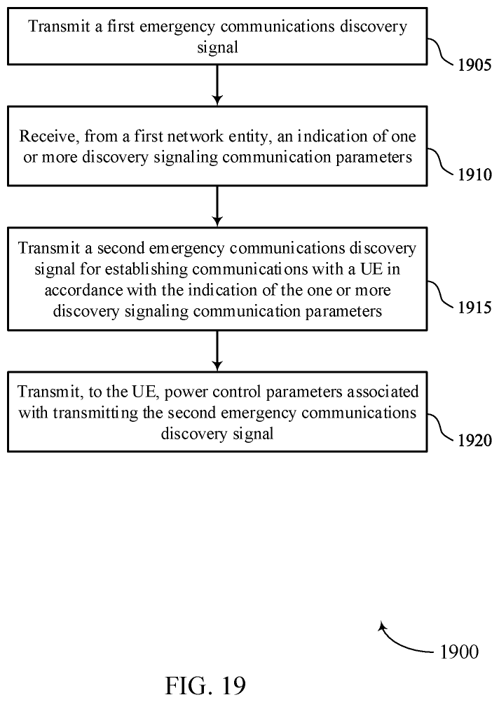

FIG. 19 shows a flowchart illustrating a method 1900 that supports interference measurement and uplink power control enhancements for emergency message relaying in accordance with one or more aspects of the present disclosure. The operations of the method 1900 may be implemented by a wireless device or its components as described herein. For example, the operations of the method 1900 may be performed by a wireless device as described with reference to FIGS. 1 through 5 and 10 through 13. In some examples, a wireless device may execute a set of instructions to control the functional elements of the wireless device to perform the described functions. Additionally, or alternatively, the wireless device may perform aspects of the described functions using special-purpose hardware.

At 1905, the method may include transmitting a first emergency communications discovery signal. The operations of 1905 may be performed in accordance with examples as disclosed herein. In some examples, aspects of the operations of 1905 may be performed by a discovery signal transmission component 1225 as described with reference to FIG. 12.

At 1910, the method may include receiving, from a first network entity, an indication of one or more discovery signaling communication parameters. The operations of 1910 may be performed in accordance with examples as disclosed herein. In some examples, aspects of the operations of 1910 may be performed by a discovery signal communication parameter component 1230 as described with reference to FIG. 12.

At 1915, the method may include transmitting a second emergency communications discovery signal for establishing communications with a UE in accordance with the indication of the one or more discovery signaling communication parameters. The operations of 1915 may be performed in accordance with examples as disclosed herein. In some examples, aspects of the operations of 1915 may be performed by a discovery signal transmission component 1225 as described with reference to FIG. 12.

At 1920, the method may include transmitting, to the UE, power control parameters associated with transmitting the second emergency communications discovery signal. The operations of 1920 may be performed in accordance with examples as disclosed herein. In some examples, aspects of the operations of 1920 may be performed by a power control parameter transmission component 1235 as described with reference to FIG. 12.

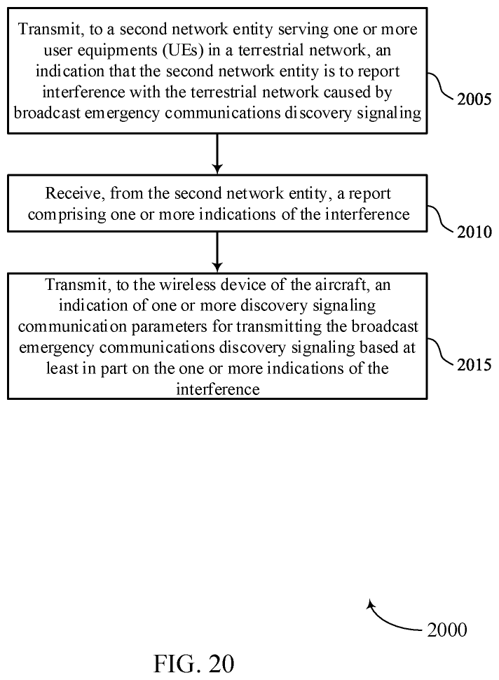

FIG. 20 shows a flowchart illustrating a method 2000 that supports interference measurement and uplink power control enhancements for emergency message relaying in accordance with one or more aspects of the present disclosure. The operations of the method 2000 may be implemented by a network entity or its components as described herein. For example, the operations of the method 2000 may be performed by a network entity as described with reference to FIGS. 1 through 5 and 14 through 17. In some examples, a network entity may execute a set of instructions to control the functional elements of the network entity to perform the described functions. Additionally, or alternatively, the network entity may perform aspects of the described functions using special-purpose hardware.

At 2005, the method may include transmitting, to a second network entity serving one or more UEs in a terrestrial network, an indication that the second network entity is to report interference with the terrestrial network caused by broadcast emergency communications discovery signaling. The operations of 2005 may be performed in accordance with examples as disclosed herein. In some examples, aspects of the operations of 2005 may be performed by an interference report component 1625 as described with reference to FIG. 16.

At 2010, the method may include receiving, from the second network entity, a report including one or more indications of the interference. The operations of 2010 may be performed in accordance with examples as disclosed herein. In some examples, aspects of the operations of 2010 may be performed by an interference report component 1625 as described with reference to FIG. 16.

At 2015, the method may include transmitting, to the wireless device of the aircraft, an indication of one or more discovery signaling communication parameters for transmitting the broadcast emergency communications discovery signaling based on the one or more indications of the interference. The operations of 2015 may be performed in accordance with examples as disclosed herein. In some examples, aspects of the operations of 2015 may be performed by a discovery signaling communication parameter transmission component 1630 as described with reference to FIG. 16.

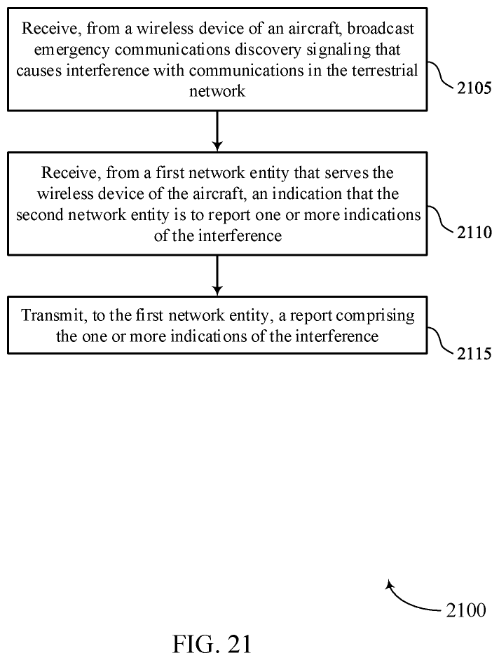

FIG. 21 shows a flowchart illustrating a method 2100 that supports interference measurement and uplink power control enhancements for emergency message relaying in accordance with one or more aspects of the present disclosure. The operations of the method 2100 may be implemented by a network entity or its components as described herein. For example, the operations of the method 2100 may be performed by a network entity as described with reference to FIGS. 1 through 5 and 14 through 17. In some examples, a network entity may execute a set of instructions to control the functional elements of the network entity to perform the described functions. Additionally, or alternatively, the network entity may perform aspects of the described functions using special-purpose hardware.

At 2105, the method may include receiving, from a wireless device of an aircraft, broadcast emergency communications discovery signaling that causes interference with communications in the terrestrial network. The operations of 2105 may be performed in accordance with examples as disclosed herein. In some examples, aspects of the operations of 2105 may be performed by an interference determination element 1635 as described with reference to FIG. 16.

At 2110, the method may include receiving, from a first network entity that serves the wireless device of the aircraft, an indication that the second network entity is to report one or more indications of the interference. The operations of 2110 may be performed in accordance with examples as disclosed herein. In some examples, aspects of the operations of 2110 may be performed by an interference report element 1640 as described with reference to FIG. 16.

At 2115, the method may include transmitting, to the first network entity, a report including the one or more indications of the interference. The operations of 2115 may be performed in accordance with examples as disclosed herein. In some examples, aspects of the operations of 2115 may be performed by an interference report transmission element 1645 as described with reference to FIG. 16.

The following provides an overview of aspects of the present disclosure:

Aspect 1: A method for wireless communication at a first UE, comprising: receiving, from a wireless device of an aircraft, broadcast emergency communications discovery signaling comprising one or more discovery signaling communication parameters for the UE outside a coverage area of a terrestrial communications network serving the UE; determining a transmit power level for transmitting an emergency message based at least in part on the one or more discovery signaling communication parameters; and transmitting the emergency message to the wireless device of the aircraft according to the determined transmit power level.

Aspect 2: The method of aspect 1, further comprising: determining one or more path loss values associated with the broadcast emergency communications discovery signaling based at least in part on the one or more discovery signaling communication parameters; and determining the transmit power level based at least in part on the one or more path loss values.

Aspect 3: The method of any of aspects 1 through 2, further comprising: receiving the one or more discovery signaling communication parameters comprising one or more power parameters associated with a beam-specific synchronization signal block, associated with a beam-specific reference signal, or any combination thereof; and determining the transmit power level based at least in part on the one or more power parameters.

Aspect 4: The method of any of aspects 1 through 3, further comprising: receiving the one or more discovery signaling communication parameters comprising one or more indications of transmission power drifting information; determining one or more predictive discovery signaling communication parameters based at least in part on the one or more indications of transmission power drifting information; and determining the transmit power level based at least in part on the one or more predictive discovery signaling communication parameters.

Aspect 5: The method of aspect 4, further comprising: determining transmit power levels for one or more repetitions of the emergency message based at least in part on the one or more indications of transmission power drifting information; and transmitting the one or more repetitions in accordance with the determined transmit power levels for the one or more repetitions of the emergency message.

Aspect 6: The method of any of aspects 1 through 5, further comprising: receiving one or more indications of emergency message repetition resources; and transmitting one or more repetitions of the emergency message on the emergency message repetition resources.

Aspect 7: The method of any of aspects 1 through 6, wherein the first UE is outside any coverage area of any terrestrial communications network.

Aspect 8: The method of any of aspects 1 through 7, wherein the broadcast emergency communications discovery signaling comprises a synchronization signal block or an announcement message.

Aspect 9: A method for wireless communication at a wireless device of an aircraft, comprising: transmitting a first emergency communications discovery signal; receiving, from a first network entity, an indication of one or more discovery signaling communication parameters; transmitting a second emergency communications discovery signal for establishing communications with a UE in accordance with the indication of the one or more discovery signaling communication parameters; and transmitting, to the UE, power control parameters associated with transmitting the second emergency communications discovery signal.

Aspect 10: The method of aspect 9, further comprising: transmitting, to the UE, the power control parameters comprising one or more power parameters associated with a beam-specific synchronization signal block, associated with a beam-specific reference signal, or any combination thereof.

Aspect 11: The method of any of aspects 9 through 10, further comprising: transmitting, to the UE, the power control parameters comprising one or more indications of transmission power drifting information.

Aspect 12: The method of any of aspects 9 through 11, further comprising: receiving an emergency message from the UE; and transmitting the emergency message to the first network entity.

Aspect 13: The method of any of aspects 9 through 12, further comprising: transmitting, to the UE, one or more indications of emergency message repetition resources; and receiving one or more repetitions of an emergency message on the emergency message repetition resources.

Aspect 14: The method of any of aspects 9 through 13, wherein the first emergency communications discovery signal and the second emergency communications discovery signal each comprise a synchronization signal block or an announcement message.

Aspect 15: The method of any of aspects 9 through 14, wherein the wireless device of the aircraft operates as a base station or a UE.

Aspect 16: A method for wireless communication at a first network entity that serves a wireless device of an aircraft, comprising: transmitting, to a second network entity serving one or more user equipments (UEs) in a terrestrial network, an indication that the second network entity is to report interference with the terrestrial network caused by broadcast emergency communications discovery signaling; receiving, from the second network entity, a report comprising one or more indications of the interference; and transmitting, to the wireless device of the aircraft, an indication of one or more discovery signaling communication parameters for transmitting the broadcast emergency communications discovery signaling based at least in part on the one or more indications of the interference.

Aspect 17: The method of aspect 16, further comprising: transmitting, to the second network entity, the wireless device of the aircraft, or both, one or more indications of resource allocation associated with the broadcast emergency communications discovery signaling.

Aspect 18: The method of aspect 17, further comprising: determining the one or more indications of resource allocation based at least in part on a location of the aircraft, a trajectory of the aircraft, information associated with the aircraft, or any combination thereof.

Aspect 19: The method of any of aspects 16 through 18, further comprising: transmitting, to the second network entity, a position of the aircraft, a trajectory of the aircraft, or both.

Aspect 20: The method of any of aspects 16 through 19, further comprising: selecting one or more transmission power parameters based at least in part on the one or more indications of the interference; and transmitting, to the wireless device of the aircraft, an indication of the one or more transmission power parameters.

Aspect 21: The method of any of aspects 16 through 20, further comprising: receiving the report comprising one or more beam indices associated with the interference; and transmitting, to the wireless device of the aircraft, an indication of the one or more beam indices.

Aspect 22: The method of any of aspects 16 through 21, wherein the broadcast emergency communications discovery signaling comprises a synchronization signal block or an announcement message.

Aspect 23: A method for wireless communication at a second network entity serving one or more user equipments (UEs) in a terrestrial network, comprising: receiving, from a wireless device of an aircraft, broadcast emergency communications discovery signaling that causes interference with communications in the terrestrial network; receiving, from a first network entity that serves the wireless device of the aircraft, an indication that the second network entity is to report one or more indications of the interference; and transmitting, to the first network entity, a report comprising the one or more indications of the interference.

Aspect 24: The method of aspect 23, further comprising: transmitting, to the first network entity, the report comprising one or more indications of downlink interference measured at the one or more UEs.

Aspect 25: The method of aspect 24, further comprising: transmitting, to the one or more UEs, an indication of one or more resources that are subject to the interference.

Aspect 26: The method of any of aspects 23 through 25, further comprising: transmitting, to the first network entity, the report comprising one or more indications of uplink interference measured at the second network entity.

Aspect 27: The method of any of aspects 23 through 26, further comprising: transmitting, to the first network entity, the report comprising one or more indications of beam indices associated with the broadcast emergency communications discovery signaling.

Aspect 28: The method of any of aspects 23 through 27, further comprising: receiving one or more indications of resource allocation associated with the broadcast emergency communications discovery signaling.

Aspect 29: The method of aspect 28, further comprising: determining one or more resource elements subject to the interference based at least in part on the one or more indications of resource allocation; and transmitting the report comprising the one or more indications of interference associated with the one or more resource elements.

Aspect 30: The method of any of aspects 23 through 29, further comprising: wherein the broadcast emergency communications discovery signaling comprises a synchronization signal block or an announcement message.

Aspect 31: An apparatus for wireless communication at a first UE, comprising a processor; memory coupled with the processor; and instructions stored in the memory and executable by the processor to cause the apparatus to perform a method of any of aspects 1 through 8.

Aspect 32: An apparatus for wireless communication at a first UE, comprising at least one means for performing a method of any of aspects 1 through 8.

Aspect 33: A non-transitory computer-readable medium storing code for wireless communication at a first UE, the code comprising instructions executable by a processor to perform a method of any of aspects 1 through 8.

Aspect 34: An apparatus for wireless communication at a wireless device of an aircraft, comprising a processor; memory coupled with the processor; and instructions stored in the memory and executable by the processor to cause the apparatus to perform a method of any of aspects 9 through 15.

Aspect 35: An apparatus for wireless communication at a wireless device of an aircraft, comprising at least one means for performing a method of any of aspects 9 through 15.

Aspect 36: A non-transitory computer-readable medium storing code for wireless communication at a wireless device of an aircraft, the code comprising instructions executable by a processor to perform a method of any of aspects 9 through 15.

Aspect 37: An apparatus for wireless communication at a first network entity that serves a wireless device of an aircraft, comprising a processor; memory coupled with the processor; and instructions stored in the memory and executable by the processor to cause the apparatus to perform a method of any of aspects 16 through 22.

Aspect 38: An apparatus for wireless communication at a first network entity that serves a wireless device of an aircraft, comprising at least one means for performing a method of any of aspects 16 through 22.

Aspect 39: A non-transitory computer-readable medium storing code for wireless communication at a first network entity that serves a wireless device of an aircraft, the code comprising instructions executable by a processor to perform a method of any of aspects 16 through 22.

Aspect 40: An apparatus for wireless communication at a second network entity serving one or more user equipments (UEs) in a terrestrial network, comprising a processor; memory coupled with the processor; and instructions stored in the memory and executable by the processor to cause the apparatus to perform a method of any of aspects 23 through 30.

Aspect 41: An apparatus for wireless communication at a second network entity serving one or more user equipments (UEs) in a terrestrial network, comprising at least one means for performing a method of any of aspects 23 through 30.

Aspect 42: A non-transitory computer-readable medium storing code for wireless communication at a second network entity serving one or more user equipments (UEs) in a terrestrial network, the code comprising instructions executable by a processor to perform a method of any of aspects 23 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
receiving, from a wireless device of an aircraft, broadcast emergency communications discovery signaling comprising one or more discovery signaling communication parameters for the UE outside a coverage area of a terrestrial communications network serving the UE;
determining a transmit power level for transmitting an emergency message based at least in part on the one or more discovery signaling communication parameters; and
transmitting the emergency message to the wireless device of the aircraft according to the determined transmit power level.

2. The method of claim 1, further comprising:
determining one or more path loss values associated with the broadcast emergency communications discovery signaling based at least in part on the one or more discovery signaling communication parameters; and
determining the transmit power level based at least in part on the one or more path loss values.

3. The method of claim 1, further comprising:
receiving the one or more discovery signaling communication parameters comprising one or more power parameters associated with a beam-specific synchronization signal block, associated with a beam-specific reference signal, or any combination thereof; and
determining the transmit power level based at least in part on the one or more power parameters.

4. The method of claim 1, further comprising:
receiving the one or more discovery signaling communication parameters comprising one or more indications of transmission power drifting information;
determining one or more predictive discovery signaling communication parameters based at least in part on the one or more indications of transmission power drifting information; and
determining the transmit power level based at least in part on the one or more predictive discovery signaling communication parameters.

5. The method of claim 4, further comprising:
determining transmit power levels for one or more repetitions of the emergency message based at least in part on the one or more indications of transmission power drifting information; and
transmitting the one or more repetitions in accordance with the determined transmit power levels for the one or more repetitions of the emergency message.

6. The method of claim 1, further comprising:
receiving one or more indications of emergency message repetition resources; and
transmitting one or more repetitions of the emergency message on the emergency message repetition resources.

7. The method of claim 1, wherein the UE is outside any coverage area of any terrestrial communications network.

8. The method of claim 1, wherein the broadcast emergency communications discovery signaling comprises a synchronization signal block or an announcement message.

9. A method for wireless communication at a wireless device of an aircraft, comprising:
transmitting a first emergency communications discovery signal;
receiving, from a first network entity, an indication of one or more discovery signaling communication parameters;
transmitting a second emergency communications discovery signal for establishing communications with a user equipment (UE) in accordance with the indication of the one or more discovery signaling communication parameters; and
transmitting, to the UE, power control parameters associated with transmitting the second emergency communications discovery signal.

10. The method of claim 9, further comprising:
transmitting, to the UE, the power control parameters comprising one or more power parameters associated with a beam-specific synchronization signal block, associated with a beam-specific reference signal, or any combination thereof.

11. The method of claim 9, further comprising:
transmitting, to the UE, the power control parameters comprising one or more indications of transmission power drifting information.

12. The method of claim 9, further comprising:
receiving an emergency message from the UE; and
transmitting the emergency message to the first network entity.

13. The method of claim 9, further comprising:
transmitting, to the UE, one or more indications of emergency message repetition resources; and
receiving one or more repetitions of an emergency message on the emergency message repetition resources.

14. The method of claim 9, wherein the first emergency communications discovery signal and the second emergency communications discovery signal each comprise a synchronization signal block or an announcement message.

15. The method of claim 9, wherein the wireless device of the aircraft operates as a base station or a UE.

16. A method for wireless communication at a first network entity that serves a wireless device of an aircraft, comprising:
transmitting, to a second network entity serving one or more user equipments (UEs) in a terrestrial network, an indication that the second network entity is to report interference with the terrestrial network caused by broadcast emergency communications discovery signaling;
receiving, from the second network entity, a report comprising one or more indications of the interference; and
transmitting, to the wireless device of the aircraft, an indication of one or more discovery signaling communication parameters for transmitting the broadcast emergency communications discovery signaling based at least in part on the one or more indications of the interference.

17. The method of claim 16, further comprising:
transmitting, to the second network entity, the wireless device of the aircraft, or both, one or more indications of resource allocation associated with the broadcast emergency communications discovery signaling.

18. The method of claim 17, further comprising:
determining the one or more indications of resource allocation based at least in part on a location of the aircraft, a trajectory of the aircraft, information associated with the aircraft, or any combination thereof.

19. The method of claim 16, further comprising:
transmitting, to the second network entity, a position of the aircraft, a trajectory of the aircraft, or both.

20. The method of claim 16, further comprising:
selecting one or more transmission power parameters based at least in part on the one or more indications of the interference; and
transmitting, to the wireless device of the aircraft, an indication of the one or more transmission power parameters.

21. The method of claim 16, further comprising:
receiving the report comprising one or more beam indices associated with the interference; and
transmitting, to the wireless device of the aircraft, an indication of the one or more beam indices.

22. The method of claim 16, wherein the broadcast emergency communications discovery signaling comprises a synchronization signal block or an announcement message.

23. A method for wireless communication at a second network entity serving one or more user equipments (UEs) in a terrestrial network, comprising:
receiving, from a wireless device of an aircraft, broadcast emergency communications discovery signaling that causes interference with communications in the terrestrial network;
receiving, from a first network entity that serves the wireless device of the aircraft, an indication that the second network entity is to report one or more indications of the interference; and
transmitting, to the first network entity, a report comprising the one or more indications of the interference.

24. The method of claim 23, further comprising:
transmitting, to the first network entity, the report comprising one or more indications of downlink interference measured at the one or more UEs.

25. The method of claim 24, further comprising:
transmitting, to the one or more UEs, an indication of one or more resources that are subject to the interference.

26. The method of claim 23, further comprising:
transmitting, to the first network entity, the report comprising one or more indications of uplink interference measured at the second network entity.

27. The method of claim 23, further comprising:
transmitting, to the first network entity, the report comprising one or more indications of beam indices associated with the broadcast emergency communications discovery signaling.

28. The method of claim 23, further comprising:
receiving one or more indications of resource allocation associated with the broadcast emergency communications discovery signaling.

29. The method of claim 28, further comprising:
determining one or more resource elements subject to the interference based at least in part on the one or more indications of resource allocation; and
transmitting the report comprising the one or more indications of interference associated with the one or more resource elements.

30. The method of claim 23, further comprising:
wherein the broadcast emergency communications discovery signaling comprises a synchronization signal block or an announcement message.
